(19) United States
(12) Patent Application Publication
(10) Pub. No.: US 2026/0104845 A1
(43) Pub. Date: Apr. 16, 2026

(54) ELECTRONIC DEVICE AND METHOD FOR RECEIVING VOICE DATA IN THE ELECTRONIC DEVICE

(71) Applicant: Samsung Electronics Co., Ltd., Suwon-si (KR)

(72) Inventors: Junghoon KIM, Suwon-si (KR); Sangsoo LEE, Suwon-si (KR); Jongmu CHOI, Suwon-si (KR); Doosuk KANG, Suwon-si (KR); Suhyun KIM, Suwon-si (KR); Jihye CHOI, Suwon-si (KR); Chiho KIM, Suwon-si (KR); Saseong SHIN, Suwon-si (KR)

(21) Appl. No.: 19/217,411

(22) Filed: May 23, 2025

Related U.S. Application Data
(63) Continuation of application No. PCT/KR2025/006644, filed on May 16, 2025.

(30) Foreign Application Priority Data
Oct. 11, 2024 (KR) 10-2024-0138736
Dec. 12, 2024 (KR) 10-2024-0184869

(51) Int. Cl. G06F 3/16; G06V 40/16; G06V 40/70; G10L 17/10; G10L 21/02; H04M 1/72409; H04R 3/02

(52) U.S. Cl. CPC G06F 3/165; G10L 17/10; G10L 21/02; H04M 1/72409; H04R 3/02; G06V 40/172; G06V 40/70; H04M 2201/42; H04M 2250/74

(57) ABSTRACT

An electronic device may comprise: communication circuitry, a display, a microphone, a camera, at least one processor, comprising processing circuitry, and memory storing instructions. According to an embodiment, the instructions may be configured to, when executed by the at least one processor individually or collectively, enable the electronic device to: based on identifying a selection of a sharing function for image data and voice data based on an input while executing a first application which uses the image data and the voice data, identify at least one external electronic device capable of providing the sharing function for the image data and the voice data among one or more external electronic devices located around the electronic device, based on identifying an external electronic device selected from among the at least one external electronic device, requesting, through communication circuitry of the electronic device, transmission of first image data and first voice data received through a first camera and a first microphone of the selected external electronic device from the selected external electronic device, identify a distance between the electronic device and the selected external electronic device, while receiving the first image data and the first voice data from the selected external electronic device through the communication circuitry, based on the distance between the electronic device and the selected external electronic device being less than a first threshold value, transmit microphone switching information, including instructions to stop the transmission of the first voice data while maintaining the reception of the first image data, to the selected external electronic device, receive second voice data through the microphone of the electronic device, while receiving the first image data from the selected external electronic device through communication circuitry, and provide the first application being executed with the first image data received from the selected external electronic device and the second voice data received through the microphone of the electronic device

### CROSS-REFERENCE TO RELATED APPLICATIONS

This application is a continuation of International Application No. PCT/KR2025/006644 designating the United States, filed on May 16, 2025, in the Korean Intellectual Property Receiving Office and claiming priority to Korean Patent Application Nos. 10-2024-0138736, filed on Oct. 11, 2024, and 10-2024-0184869, filed on Dec. 12, 2024, in the Korean Intellectual Property Office, the disclosures of each of which are incorporated by reference herein in their entireties.

### BACKGROUND

### Field

The disclosure relates to an electronic device and a method for receiving voice data in the electronic device.

### Description of Related Art

An electronic device may receive image data and audio data obtained through a camera and a microphone included in the electronic device while executing an application utilizing the camera and microphone.

### SUMMARY

According to an embodiment, an electronic device may comprise communication circuitry, a display, a microphone, a camera, at least one processor, comprising processing circuitry, and memory storing instructions. According to an embodiment, the instructions may, when executed by the at least one processor individually or collectively, cause the electronic device to: based on identifying a selection of a sharing function for image data and voice data based on an input while executing a first application which uses the image data and the voice data, identify at least one external electronic device capable of providing the sharing function for the image data and the voice data among one or more external electronic devices located within a specified distance of the electronic device. According to an embodiment, the instructions may, when executed by the at least one processor individually or collectively, cause the electronic device to, identifying an external electronic device selected among the at least one external electronic device, request, through the communication circuitry, transmission of first image data and first voice data received through a first camera and a first microphone of the selected external electronic device from the selected external electronic device. According to an embodiment, the instructions may, when executed by the at least one processor individually or collectively, cause the electronic device to identify a distance between the electronic device and the selected external electronic device, while receiving the first image data and the first voice data from the selected external electronic device through the communication circuitry. According to an embodiment, the instructions may, when executed by the at least one processor individually or collectively, cause the electronic device to based on the distance between the electronic device and the selected external electronic device being less than a first threshold value, transmit microphone switching information, including information to stop the transmission of the first voice data while maintaining the reception of the first image data, to the selected external electronic device According to an embodiment, the instructions may, when executed by the at least one processor individually or collectively, cause the electronic device to receive second voice data through the microphone of the electronic device, while receiving the first image data from the selected external electronic device through communication circuitry. According to an embodiment, the instructions may, when executed by the at least one processor individually or collectively, cause the electronic device to provide the first application being executed with the first image data received from the selected external electronic device and the second voice data received through the microphone of the electronic device.

According to an embodiment, a method for receiving voice data in an electronic device may comprise: based on identifying a selection of a sharing function for image data and voice data based on an input while executing a first application which uses the image data and the voice data, identifying at least one external electronic device capable of providing the sharing function for the image data and the voice data among one or more external electronic devices located within a specified distance of the electronic device. According to an embodiment, the method may comprise, based on identifying an external electronic device selected from among the at least one external electronic device, requesting, through communication circuitry of the electronic device, transmission of first image data and first voice data received through a first camera and a first microphone of the selected external electronic device from the selected external electronic device. According to an embodiment, the method may comprise identifying a distance between the electronic device and the selected external electronic device, while receiving the first image data and the first voice data from the selected external electronic device through the communication circuitry. According to an embodiment, the method may comprise, based on the distance between the electronic device and the selected external electronic device being less than a first threshold value, transmitting microphone switching information, including information to stop the transmission of the first voice data while maintaining the reception of the first image data, to the selected external electronic device. According to an embodiment, the method may comprise receiving second voice data through the microphone of the electronic device, while receiving the first image data from the selected external electronic device through communication circuitry. According to an embodiment, the method may comprise providing the first application being executed with the first image data received from the selected external electronic device and the second voice data received through the microphone of the electronic device.

In a non-transitory computer-readable storage medium storing instructions which, when executed by at least one processor, comprising processing circuitry, individually and/or collectively, of an electronic device, cause the electronic device to perform at least one operation, the at least one operation may comprise: based on identifying a selection of a sharing function for image data and voice data based on an input of a user while executing a first application which uses the image data and the voice data, identifying at least one external electronic device capable of providing the sharing function for the image data and the voice data among one or more external electronic devices located within a specified distance of the electronic device. According to an embodiment, the at least one operation may comprise, based on identifying an external electronic device selected from among the at least one external electronic device, requesting, through communication circuitry of the electronic device, transmission of first image data and first voice data received through a first camera and a first microphone of the selected external electronic device from the selected external electronic device. According to an embodiment, the at least one operation may comprise identifying a distance between the electronic device and the selected external electronic device, while receiving the first image data and the first voice data from the selected external electronic device through the communication circuitry. According to an embodiment, the at least one operation may comprise, based on the distance between the electronic device and the selected external electronic device being less than a first threshold value, transmitting microphone switching information, including information to stop the transmission of the first voice data while maintaining the reception of the first image data, to the selected external electronic device. According to an embodiment, the at least one operation may comprise receiving second voice data through the microphone of the electronic device, while receiving the first image data from the selected external electronic device through communication circuitry According to an embodiment, the at least one operation may comprise providing the first application being executed with the first image data received from the selected external electronic device and the second voice data received through the microphone of the electronic device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic device in a network environment according to various embodiments;

FIG. 2 is a diagram illustrating an example operation of sharing a camera and a microphone of an external electronic device in an electronic device according to various embodiments;

FIG. 3A is a block diagram illustrating an example configuration of an electronic device according to various embodiments;

FIG. 3B is a block diagram illustrating an example configuration of a processor of an electronic device according to various embodiments;

FIGS. 4A, 4B, and 4C are diagrams illustrating an example operation for receiving voice data in an electronic device according to various embodiments;

FIGS. 5A, 5B, and 5C are flowcharts illustrating an example operation for receiving voice data in an electronic device according to various embodiments;

FIG. 6 is a signal flow diagram illustrating an example operation of identifying at least one external electronic device capable of providing a sharing function for image data and voice data in an electronic device according to various embodiments;

FIG. 7 is a signal flow diagram illustrating an example operation of receiving image data and voice data from an external electronic device in an electronic device according to various embodiments;

FIG. 8 is a signal flow diagram illustrating an example operation of identifying a distance between an electronic device and an external electronic device in the electronic device according to various embodiments;

FIG. 9 is a signal flow diagram illustrating an example operation of identifying voice data of a designated user in an electronic device according to various embodiments;

FIG. 10 is a signal flow diagram illustrating an example operation of identifying image data of a specified user in an electronic device according to various embodiments; and

FIG. 11 is a signal flow diagram illustrating an example operation of receiving voice data in an electronic device according to various embodiments.

### DETAILED DESCRIPTION

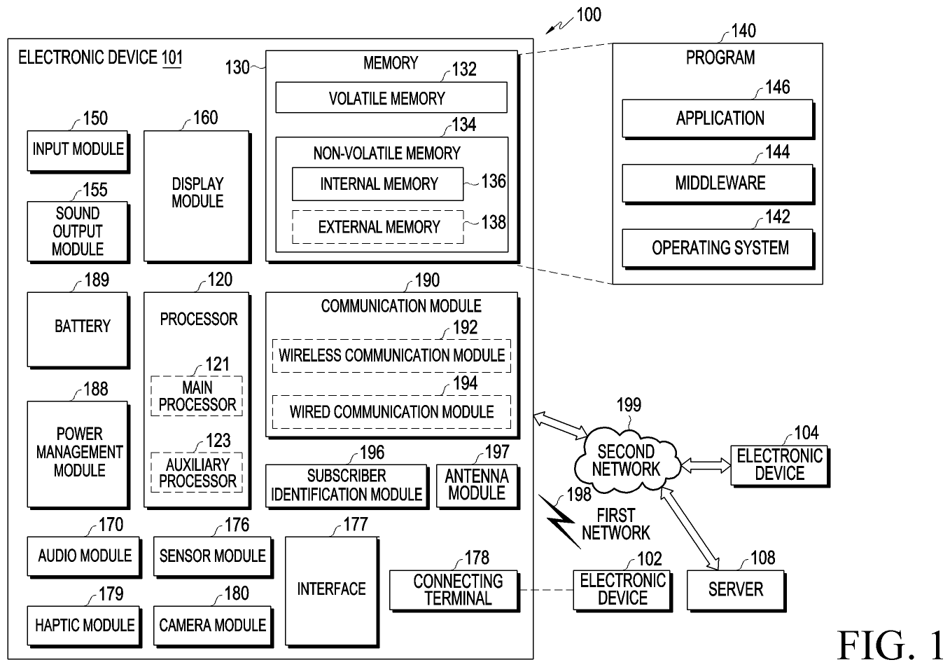

FIG. 1 is a block diagram illustrating an example electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, e.g., a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include an antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

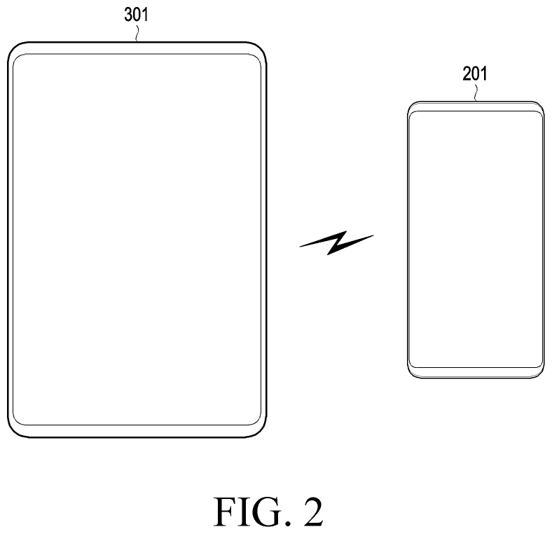

FIG. 2 is a diagram illustrating an example operation of sharing a camera and a microphone of an external electronic device in an electronic device according to various embodiments.

Referring to FIG. 2, according to an embodiment, the electronic device 301 may provide a first application with image data and voice data received through the camera and microphone included in the electronic device 301 while executing the first application using the camera and microphone in the electronic device 301 (e.g., a first application related to video call and/or a first application related to video capturing).

According to an embodiment, when identifying a selection of a sharing function for image data and voice data based on the user's input while executing the first application using the camera and microphone, the electronic device 301 may identify at least one external electronic device capable of providing the sharing function for image data and voice data among one or more external electronic devices located around the electronic device and, when identifying an external electronic device 201 selected by an input (e.g., the user's input) from among the at least one external electronic device, request transmission of first image data and first voice data obtained through the first camera and first microphone of the external electronic device 201, from the external electronic device 201.

According to an embodiment, while receiving the first image data and the first voice data from the external electronic device 201, if at least one of when the distance between the electronic device 301 and the external electronic device 201 is less than a first threshold, when an image obtained through the camera of the electronic device includes an image of a specified user (e.g., the owner of the electronic device and the external electronic device), when the voice intensity of the voice data of the specified user (e.g., the owner of the electronic device and the external electronic device) obtained through the microphone of the electronic device is equal to or greater than a second threshold, or when the signal intensity between the electronic device 301 and the external electronic device 201 is equal to or greater than a third threshold, the electronic device 301 may transmit microphone switching information instructing to stop the transmission of the first voice data to the external electronic device 201 and, while receiving the first image data from the external electronic device, receive second voice data obtained through the microphone of the electronic device 301.

According to an embodiment, when receiving a request for the first image data and the first voice data obtained through the first camera and the first microphone of the external electronic device 201 from the electronic device 301, the external electronic device 201 may transmit the first image data and the first voice data received through the first camera and the first microphone of the external electronic device 201 to the electronic device 301.

According to an embodiment, to prevent and/or reduce echo, when the audio data output through the speaker of the electronic device 301 is received through the first microphone of the external electronic device 201, the external electronic device 201 may transmit, to the electronic device 301, first voice data obtained by filtering (removing) the audio data from the first voice data received through the first microphone of the external electronic device 201.

According to an embodiment, when receiving the microphone switching information instructing to stop the transmission of the first voice data received through the first microphone of the external electronic device 201 from the electronic device 301, the external electronic device 201 may stop the transmission of the first voice data received through the first microphone of the external electronic device 201 while transmitting the first image data received through the first camera of the external electronic device 201.

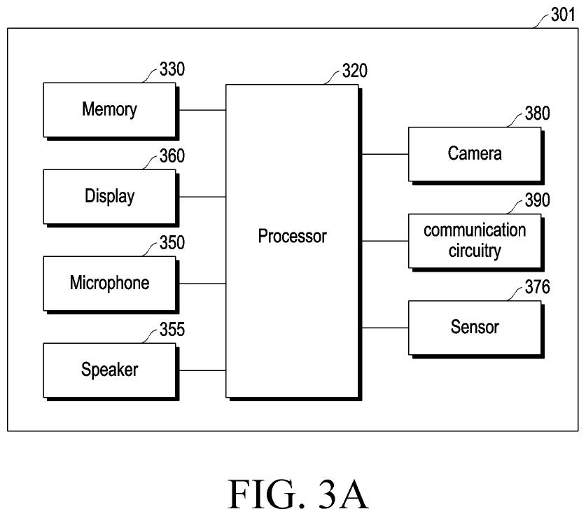

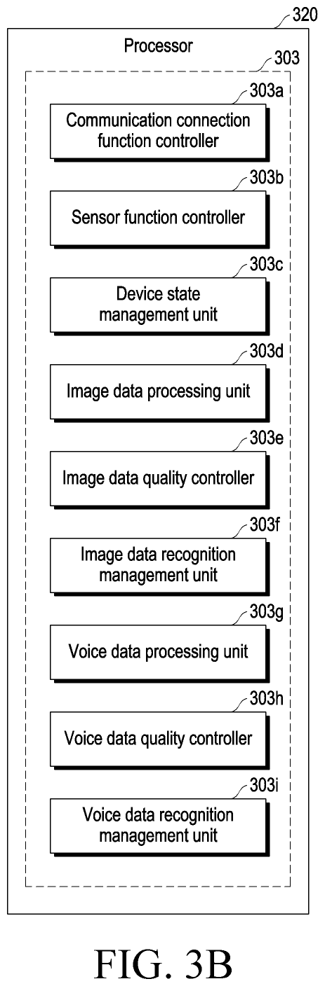

FIG. 3A is a block diagram illustrating an example configuration of an electronic device according to various embodiments, and FIG. 3B is a block diagram illustrating an example configuration of a processor of an electronic device according to various embodiments.

Although FIGS. 3A and 3B according to an embodiment illustrate an example configuration of the electronic device 301 of FIG. 2, the configuration of the electronic device 301 of FIGS. 3A and 3B may be equally applied to the external electronic device 201 of FIG. 2.

Referring to FIG. 3A, according to an embodiment, an electronic device 301 (e.g., the electronic device 101 of FIG. 1 and/or the first electronic device 301 of FIG. 2) may include a processor (e.g., including processing circuitry) 320, memory 330, a microphone 350, a speaker 355, a display 360, a camera 380, a sensor 376, and communication circuitry 390.

According to an embodiment, the processor 320 may include various processing circuitry and control the overall control operation of the electronic device 301. According to an embodiment, the processor 320 may execute software (e.g., the program 140 of FIG. 1) to control at least one other component (e.g., a hardware or software component) of the electronic device 301 connected with the processor 320 and may perform data processing or computation based on instructions. An instruction according to an embodiment may include a command in a machine language that may be processed by the electronic device 301 or the processor 320. For example, the instruction may include a command corresponding to an operation instruction used in the program. The processor 320 may be implemented to be substantially the same or similar to the processor 120 of FIG. 1.

According to an embodiment, the processor 320 may identify at least one external electronic device capable of providing a sharing function for image data and voice data while executing a first application using image data and voice data.

According to an embodiment, the processor 320 may provide the image data and voice data received through the camera 380 and the microphone 350 of the electronic device 301 to the first application while executing the first application using image data and voice data.

According to an embodiment, when identifying a selection of the sharing function of the image data and voice data based on the user's input while providing the image data and voice data received through the camera 380 and the microphone 350 of the electronic device 301 to the first application, the processor 320 may identify at least one external electronic device 201 that has transmitted information related to the sharing function of the image data and voice data among device information received from one or more electronic devices 301 located around the electronic device 301 through the communication circuitry 390.

According to an embodiment, the processor 320 may receive the device information received from one or more electronic devices located around the electronic device 301 through BLE communication circuitry among the communication circuitry 390.

According to an embodiment, the processor 320 may display a list of at least one external electronic device having transmitted information related to the sharing function of the image data and voice data through the display 360.

According to an embodiment, when identifying the external electronic device (e.g., the external electronic device 201 of FIG. 2) selected based on the user's input from among the at least one external electronic device having transmitted the information related to the sharing function of the image data and voice data, the processor 320 may request transmission of the first image data and first voice data received through the first camera and the first microphone of the selected external electronic device from the selected external electronic device (e.g., the external electronic device 201 of FIG. 2) through the communication circuitry 390.

According to an embodiment, when identifying the external electronic device (e.g., the external electronic device 201 of FIG. 2) selected based on the user's input, the processor 320 may measure the distance between the electronic device and the selected external electronic device and, when identifying that the distance between the electronic device 301 and the selected external electronic device is a distance at which no echo occurs, request transmission of the first image data and first voice data received through the first camera and first microphone of the selected external electronic device from the selected external electronic device (e.g., the external electronic device 201 of FIG. 2).

According to an embodiment, when receiving the first image data and first voice data from the selected external electronic device (e.g., the external electronic device 201 of FIG. 2), the processor 320 may provide the first image data and the first voice data to the first application.

According to an embodiment, while receiving the first image data and first voice data from the selected external electronic device (e.g., the external electronic device 201 of FIG. 2), the processor 320 may compare the distance between the electronic device 301 and the external electronic device with a first threshold.

According to an embodiment, to prevent and/or reduce echo, the first voice data received from the selected external electronic device may include voice data obtained by filtering audio data output through a speaker 355 of the electronic device 301, and the audio data may include audio data input to the first microphone of the selected external electronic device.

According to an embodiment, when identifying a movement of the electronic device 301 using an acceleration sensor among the sensors 376, the processor 320 may identify (measure) the distance between the electronic device 301 and the selected first external electronic device using distance measurement technology based on a network (e.g., Bluetooth low energy (BLE)), Wi-Fi, and/or UWB).

According to an embodiment, when the distance between the electronic device 301 and the selected external electronic device is equal to or greater than the first threshold, the processor 320 may maintain the reception of the first image data and the first voice data from the selected external electronic device through the communication circuitry 390.

According to an embodiment, when the distance between the electronic device 301 and the selected external electronic device is less than the first threshold, the processor 320 may transmit microphone switching information instructing to stop the transmission of the first voice data to the selected external electronic device and, while receiving the first image data from the selected external electronic device through the communication circuitry 390, receive voice data (e.g., second voice data) through the microphone 350 of the electronic device 301.

According to an embodiment, the processor 320 may provide the first image data received from the selected external electronic device (e.g., the external electronic device 201 of FIG. 2) and the voice data (e.g., the second voice data) received through the microphone 350 of the electronic device 301 to the first application.

According to an embodiment, when receiving first information indicating that image data of a specified user (e.g., the owner of the electronic device 301 and the selected external electronic device) is included in the first image data received through the first camera of the selected external electronic device from the selected external electronic device (e.g., the external electronic device 201 of FIG. 2) while receiving the first image data from the selected external electronic device through the communication circuitry 390 and receiving the voice data through the microphone 350 of the electronic device 301, the processor 320 may stop the reception of the voice data through the microphone 350 of the electronic device 301, request transmission of the first voice data from the selected external electronic device, and receive the first image data and first voice data from the selected external electronic device.

According to an embodiment, the image data of the specified user may be prespecified among the image data stored in the memory 330.

According to an embodiment, the image data of the specified user may represent the image data corresponding to the face of the specified user.

According to an embodiment, as the image data of the specified user, the image data of the user included in the image data received through the camera 380 of the electronic device 301 may be stored, as the image data of the specified user, in the memory 330 while executing the first application using the image data and voice data before selecting the sharing function of the image data and voice data.

According to an embodiment, when receiving second information indicating reception of voice data of the specified user (e.g., the owner of the electronic device 301 and the external electronic device) through the first microphone of the external electronic device from the selected external electronic device (e.g., the external electronic device 201 of FIG. 2) while receiving the first image data from the selected external electronic device through the communication circuitry 390 and receiving the voice data (e.g., the second voice data) through the microphone 350 of the electronic device 301, the processor 320 may stop the reception of the voice data through the microphone 350 of the electronic device 301, request transmission of the first voice data from the selected external electronic device, and receive the first image data and first voice data from the selected external electronic device.

According to an embodiment, the processor 320 may identify that the voice intensity of the voice data of the specified user received through the first microphone of the selected external electronic device is equal to or greater than the second threshold based on the second information.

According to an embodiment, the voice data of the specified user may be predesignated among the voice data stored in the memory 330.

According to an embodiment, as the voice data of the specified user, the voice data received through the microphone 350 of the electronic device 301 may be stored, as the voice data of the specified user, in the memory 330 while executing the first application using the image data and voice data before selecting the sharing function of the image data and voice data.

According to an embodiment, when identifying that the image data of the specified user is included in the image data (e.g., the second image data) received through the camera 380 of the electronic device while receiving the first image data and first voice data from the selected external electronic device (e.g., the external electronic device 201 of FIG. 2), the processor 320 may transmit microphone switching information instructing to stop the transmission of the first voice data to the selected external electronic device and, while receiving the first image data from the selected external electronic device through the communication circuitry 390, receive voice data (e.g., second voice data) through the microphone 350 of the electronic device 301.

According to an embodiment, the processor 320 may identify the voice data received through the microphone 350 of the electronic device 301 while receiving the first image data and first voice data from the selected external electronic device (e.g., the external electronic device 201 of FIG. 2) and, when identifying that the voice data received through the microphone 350 of the electronic device 301 is the voice data of the specified user, compare the voice intensity of the voice data of the specified user with the second threshold.

According to an embodiment, when the voice intensity of the voice data of the specified user is equal to or greater than the second threshold, the processor 320 may transmit microphone switching information instructing to stop the transmission of the first voice data to the selected external electronic device and, while receiving the first image data from the selected external electronic device through the communication circuitry 390, receive second voice data through the microphone 350 of the electronic device 301.

According to an embodiment, when identifying that the distance between the electronic device 301 and the selected external electronic device is less than the first threshold, and the image data of the specified user is included in the image data (e.g., the second image data) received through the camera 380 of the electronic device 301 while receiving the first image data and first voice data from the selected external electronic device (e.g., the external electronic device 201 of FIG. 2), the processor 320 may transmit microphone switching information instructing to stop the transmission of the first voice data to the selected external electronic device and, while receiving the first image data from the external electronic device through the communication circuitry 390, receive voice data (e.g., second voice data) through the microphone 350 of the electronic device.

According to an embodiment, when identifying that the distance between the electronic device 301 and the external electronic device is less than the first threshold, and the voice intensity of the voice data of the user received through the microphone 350 of the electronic device 301 is equal to or greater than the second threshold while receiving the first image data and first voice data from the external electronic device (e.g., the external electronic device 201 of FIG. 2), the processor 320 may transmit microphone switching information instructing to stop the transmission of the first voice data to the selected external electronic device and, while receiving the first image data from the selected external electronic device through the communication circuitry 390, receive voice data through the microphone 350 of the electronic device 301.

According to an embodiment, when identifying that the distance between the electronic device 301 and the external electronic device is less than the first threshold, and the image data of the specified user is included in the image data (e.g., the second image data) received through the camera 380 of the electronic device 301, and when the voice intensity of the voice data of the specified user received through the microphone 350 of the electronic device 301 is equal to or greater than the second threshold while receiving the first image data and first voice data from the selected external electronic device (e.g., the external electronic device 201 of FIG. 2), the processor 320 may transmit microphone switching information instructing to stop the transmission of the first voice data to the selected external electronic device and, while receiving the first image data from the selected external electronic device through the communication circuitry 390, receive voice data (e.g., second voice data) through the microphone 350 of the electronic device 301.

According to an embodiment, when identifying that the execution of the first application (e.g., a first application related to video call and/or a first application related to video capturing) using the camera 380 and the microphone 350 terminates in the electronic device 301, the processor 320 may instruct to stop the transmission of the first image data and first voice data to the selected external electronic device.

According to an embodiment, when identifying that the sharing function of the image data and voice data releases while executing the first application (e.g., a first application related to video call and/or a first application related to video capturing) using the camera 380 and the microphone 350 in the electronic device 301, the processor 320 may instruct to stop the transmission of the first image data and first voice data to the selected external electronic device.

According to an embodiment, to generate the microphone switching information in the electronic device 301, the processor 320 may input information identified in the electronic device 301 (e.g., distance information between the electronic device 301 and the external electronic device, information regarding whether the image data of the specified user is included in the image data (e.g., the second image data) received through the camera of the electronic device 301, the voice intensity information about the voice data of the specified user received through the microphone of the electronic device 301, and/or signal strength information between the electronic device 301 and the external electronic device), information received from the selected external electronic device (e.g., first information indicating that the image data of the specified user is included in the first image data received through the first camera of the selected external electronic device and/or second information indicating the reception of the voice data of the specified user through the first microphone of the selected first external electronic device from the selected first external electronic device), as input values to a trained artificial intelligence model and, based on the output values of the artificial intelligence model, determine whether to receive the first voice data obtained through the first microphone of the selected external electronic device from the selected external electronic device or to receive voice data (e.g., the second voice data) through the microphone 350 of the electronic device 301.

According to an embodiment, when the first application using the image data and voice data is newly installed on the electronic device 301 or its version is changed, the processor 320 may transmit information related to whether the first application is present and/or whether it is changed to one or more external electronic devices located around the electronic device 301.

According to an embodiment, as the processor 320 performs data encryption to inform the selected external electronic device connected to the management server on the same account as the electronic device 301 of the information related to whether the first application using the image data and voice data is present and/or whether it is changed, the selected external electronic device may interpret the encrypted data so that the selected external electronic device may identify whether the first application is present and/or whether it is changed in the electronic device 301.

According to an embodiment, the processor 320 may provide a list of at least one external electronic device including the first application using the image data and voice data among one or more external electronic devices connected to the management server on the same account as the electronic device 301 and/or the type of the first application which may be provided from each of the at least one external electronic device.

According to an embodiment, the processor 320 may analyze the voice data received through the microphone 350 of the electronic device 301 to identify the voice data of the specified user and identify whether the specified user uses the current electronic device 301 based on identifying the voice data of the specified user.

According to an embodiment, when identifying the reception of image data including the image data of the specified user through the camera 380 of the electronic device 301 and/or identifying the voice data of the specified user through the microphone 350 of the electronic device 301, the processor 320 may identify that the specified user is currently using the electronic device 301 and share information indicating that the specified user is currently using the electronic device 301 with the selected external electronic device.

According to an embodiment, the processor 320 may identify the distance, position, and direction between the electronic device 301 and the selected external electronic device through measurement of the reception sensitivity between the electronic device 301 and the selected external electronic device.

According to an embodiment, the memory 330 may be implemented to be substantially the same or similar to the memory 130 of FIG. 1.

According to an embodiment, device information received from one or more external electronic devices located around the electronic device 301 may be stored in the memory 330.

According to an embodiment, the image data of the specified user and voice data of the specified user may be stored in the memory 330.

According to an embodiment, the image data of the specified user may include the face of the specified user.

According to an embodiment, the display 360 may be implemented to be substantially identical or similar to the display module 160 of FIG. 1.

According to an embodiment, the sensor 376 may be implemented to be substantially identical or similar to the sensor module 176 of FIG. 1.

According to an embodiment, the movement of the electronic device may be detected using an acceleration sensor among the sensors 376.

According to an embodiment, the camera 380 may be implemented to be substantially identical or similar to the camera module 180 of FIG. 1.

According to an embodiment, the camera 380 may obtain image data including the image data of the specified user and transmit it to the processor 320.

According to an embodiment, the communication circuitry 390 may be implemented to be substantially identical or similar to the communication module 190 of FIG. 1.

According to an embodiment, the communication circuitry 390 may establish a communication connection with an external electronic device (e.g., another electronic device, or server) through various types of communication methods, and transmit and/or receive data. As described above, the communication method may include a communication method for establishing a direct communication connection such as Bluetooth and Wi-Fi direct, a communication method using an access point (AP) (e.g., Wi-Fi communication), or a communication method using cellular communication using a base station (e.g., 3G, 4G/LTE, 5G).

Referring to FIG. 3B, the processor 320 according to an embodiment may include a voice data management unit 303, and the voice data management unit 303 may include a communication connection function controller 303a, a sensor function controller 303b, a device state management unit 303c, an image data processing unit 303d, an image data quality controller 303e, an image data recognition management unit 303f, a voice data processing unit 303g, a voice data quality controller 303h, and a voice data recognition unit 303i, each of which may include various circuitry and/or executable program instructions.

The voice data management unit 303 according to an embodiment may be included in the processor 320 or may be separately configured in the electronic device 301.

According to an embodiment, the communication connection function controller 303a may control a hardware component that provides communication connection technology, such as Wi-Fi communication circuitry, Bluetooth communication circuitry, and/or UWB communication circuitry included in the communication circuitry 390, perform a data transmission/reception function through control of the hardware component that provides communication connection technology, and measure (identify) the distance between the electronic device and the external electronic future through communication connection technology.

According to an embodiment, the sensor function controller 303b may control the sensor 376 that obtains acceleration information and/or geomagnetic information.

According to an embodiment, the device state management unit 303c may search for one or more external electronic devices in the vicinity through the communication connection function controller 303a, provide a function for communication connection, and provide a network connection between the electronic device 301 and the external electronic device to provide data communication services between the devices.

According to an embodiment, the device state management unit 303c may manage the communication connection quality between the electronic device 301 and the external electronic device, and measure the relative position and distance between the electronic device 301 and the external electronic device.

According to an embodiment, the device state management unit 303c may determine the movement of the electronic device 301 by obtaining the acceleration or geomagnetic-related information about the electronic device 301 obtained through the sensor function controller 303b.

According to an embodiment, the device state management unit 303c may store and manage information related to the electronic device 301 and the surrounding external electronic device, and may provide information related to the electronic device 301 and the surrounding external electronic device to an application and/or system.

According to an embodiment, the image data processing unit 303d may manipulate hardware components related to input/output of image data, such as the camera 380 and/or display 360, and provide input/output and control of image data to a higher layer.

According to an embodiment, the image data quality controller 303e may obtain communication connection information for transmitting/receiving image data with the external electronic device obtained from the device state management unit 303c, perform image data transmission and reception with the external electronic device based on the obtained communication connection information, and control the quality of image data transmitted and received according to real-time network quality.

According to an embodiment, the image data recognition management unit 303f may recognize the specified user (e.g., the owner of the electronic device 301) from image data obtained from the camera 380 and identify the relative positions of the electronic device 301 and the specified user to determine whether the specified user uses the electronic device 301.

According to an embodiment, the voice data processing unit 303g may manipulate hardware components related to voice input/output, such as the microphone 350 and speaker 355, and may provide voice data input/output and control to a higher layer.

According to an embodiment, the voice data quality controller 303h may filter audio data input to the microphone 301 to prevent and/or reduce audio data output through the speaker 355 from being input back to the electronic device 301 through the microphone.

According to an embodiment, the voice data recognition unit 303i may analyze the voice data obtained through the microphone 350 to determine whether the specified user uses the electronic device 301, and transmit information related to whether the specified user uses the electronic device 301 to the device state management unit 303c to use it to determine whether the specified user is currently using the electronic device 301.

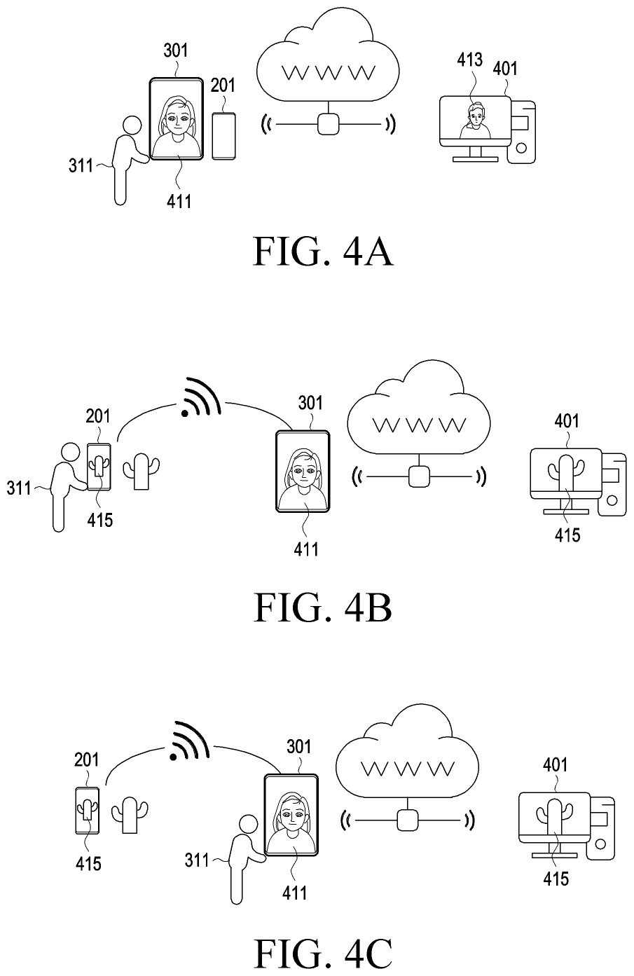

FIGS. 4A, 4B, and 4C are diagrams illustrating an example operation for receiving voice data in an electronic device according to various embodiments.

Referring to FIG. 4A, according to an embodiment, the electronic device (e.g., the first electronic device 301 of FIG. 2 and/or the electronic device 301 of FIG. 3A) may execute the first application for video call and, while performing video call with the first external electronic device 401, provide image data and voice data received through the camera (e.g., the camera 380 of FIG. 3A) and the microphone (e.g., the microphone 350 of FIG. 3A) of the electronic device 301 to the first application.

According to an embodiment, the electronic device 301 may display image data 411 received through the camera of the first external electronic device 401 performing a video call through the display (e.g., the display 360 of FIG. 3A) of the electronic device 301, and output voice data received through the microphone of the first external electronic device 401 through the speaker (e.g., the speaker 355 of FIG. 3A) of FIG. 3A.

According to an embodiment, the first external electronic device 401 may display image data 413 received through the camera of the electronic device 301 through the display of the first external electronic device 401, and output voice data received through the microphone of the electronic device 301 through the speaker of the first external electronic device 401.

Referring to FIG. 4B, according to an embodiment, when identifying a selection of a sharing function of image data and voice data based on the user's input while executing a first application for video call, the electronic device (e.g., the first electronic device 301 of FIG. 2 and/or the electronic device 301 of FIG. 3A) may identify an external electronic device 201 that has information related to the sharing function of image data and voice data among device information received from at least one electronic device located around the electronic device 301 through communication circuitry (e.g., the communication circuitry 390 of FIG. 3A) of the electronic device 301.

According to an embodiment, the electronic device 301 may identify the external electronic device 201 selected by the user's input and request transmission of first image data and first voice data received through the first camera and first microphone of the selected external electronic device 201 from the selected external electronic device 201 that has established communication.

According to an embodiment, when receiving the first image data and first voice data from the selected external electronic device 201, the electronic device 301 may provide the first image data and first voice data to the first application and transmit the first image data and first voice data to the first external electronic device 401 which is performing video call through the first application.

According to an embodiment, the first external electronic device 401 may display image data 415 received through the first camera of the selected external electronic device 201 through the display of the first external electronic device 401, and output voice data received through the first microphone of the selected external electronic device 201 through the speaker of the first external electronic device 401.

Referring to FIG. 4C, according to an embodiment, when identifying that image data of the specified user 311 is included in the image data received through the camera of the electronic device 301 while receiving the first image data and first voice data from the selected external electronic device 201, the electronic device (e.g., the first electronic device 301 of FIG. 2 and/or the electronic device 301 of FIG. 3A) may transmit microphone switching information instructing to stop the transmission of the first voice data to the selected external electronic device 201 and receive voice data (e.g., second voice data) through the microphone (e.g., the microphone 350 of FIG. 3A) of the electronic device 301.

According to an embodiment, the electronic device 301 may provide the first application with the first image data received from the selected external electronic device 201 and the voice data (e.g., the second voice data) received through the microphone of the electronic device 301 and transmit the first image data and voice data (e.g., the second voice data) to the first external electronic device 401 which is performing video call through the first application.

According to an embodiment, the first external electronic device 401 may display image data 415 received through the first camera of the selected external electronic device 201 through the display of the first external electronic device 401, and output voice data received through the microphone of the electronic device 301 through the speaker of the first external electronic device 401.

According to an embodiment, an electronic device (101 of FIG. 1; 301 of FIG. 2; 301 of FIG. 3A) may comprise: communication circuitry (190 of FIG. 1; 390 of FIG. 3A), a display (160 of FIG. 1; 360 of FIG. 3A), a microphone (350 of FIG. 3A), a camera (180 of FIG. 1; 380 of FIG. 3A), at least one processor, comprising processing circuitry (120 of FIG. 1; 320 of FIGS. 3A and 3B), and memory (130 of FIG. 1; 330 of FIG. 3) storing instructions. According to an embodiment, the instructions may, when executed by the at least one processor individually or collectively, cause the electronic device to, based on identifying a selection of a sharing function for image data and voice data based on an input while executing a first application which uses the image data and the voice data, identify at least one external electronic device capable of providing the sharing function for the image data and the voice data among one or more external electronic devices located around the electronic device. According to an embodiment, the instructions may, when executed by the at least one processor individually or collectively, cause the electronic device to, based on identifying an external electronic device (e.g., 201 of FIG. 3) selected among the at least one external electronic device, request, through the communication circuitry, transmission of first image data and first voice data received through a first camera and a first microphone of the selected external electronic device from the selected external electronic device. According to an embodiment, the instructions may, when executed by the at least one processor individually or collectively, cause the electronic device to identify a distance between the electronic device and the selected external electronic device, while receiving the first image data and the first voice data from the selected external electronic device through the communication circuitry. According to an embodiment, the instructions may, when executed by the at least one processor individually or collectively, cause the electronic device to based on the distance between the electronic device and the selected external electronic device being less than a first threshold value, transmit microphone switching information, including instructions to stop the transmission of the first voice data while maintaining the reception of the first image data, to the selected external electronic device. According to an embodiment, the instructions may, when executed by the at least one processor individually or collectively, cause the electronic device to receive second voice data through the microphone of the electronic device, while receiving the first image data from the selected external electronic device through communication circuitry According to an embodiment, the instructions may, when executed by the at least one processor individually or collectively, cause the electronic device to provide the first application being executed with the first image data received from the selected external electronic device and the second voice data received through the microphone of the electronic device.

According to an embodiment, the instructions may, when executed by the at least one processor individually or collectively, cause the electronic device to, based on receiving, from the selected external electronic device, first information indicating that image data of a specified user is included in the first image data received through the first camera of the selected external electronic device while receiving the first image data from the selected external electronic device through the communication circuitry and the second voice data through the microphone of the electronic device, stop the reception of the second voice data through the microphone of the electronic device, request transmission of the first voice data from the selected external electronic device, and receive the first image data and the first voice data from the selected external electronic device.

According to an embodiment, the instructions may, when executed by the at least one processor individually or collectively, cause the electronic device to analyze the first image data and identify whether first information indicating that the first image data includes image data corresponding to a face of the specified user based on a result of the analysis.

According to an embodiment, the instructions may, when executed by the at least one processor individually or collectively, cause the electronic device to, based on receiving, from the selected external electronic device, second information indicating reception of voice data of the specified user through the first microphone of the selected external electronic device while receiving the first image data from the selected external electronic device through the communication circuitry and the second voice data received through the microphone of the electronic device, stop the reception of the second voice data through the microphone of the electronic device, request transmission of the first voice data from the selected external electronic device, and receive the first image data and the first voice data from the selected external electronic device.

According to an embodiment, the instructions may, when executed by the at least one processor individually or collectively, cause the electronic device to: while receiving the first image data and the first voice data from the selected external electronic device through the communication circuitry, identify whether image data of the specified user is included in second image data received through the camera of the electronic device. According to an embodiment, the instructions may, when executed by the at least one processor individually or collectively, cause the electronic device to, based on identifying that the image data of the specified user is included in the second image data, transmit the microphone switching information, including instructions to stop the transmission of the first voice data, to the selected external electronic device.

According to an embodiment, the instructions may, when executed by the at least one processor individually or collectively, cause the electronic device to: while receiving the first image data and the first voice data from the selected external electronic device through communication circuitry, identify voice data received through the microphone of the electronic device, According to an embodiment, the instructions may, when executed by the at least one processor individually or collectively, cause the electronic device to, based on the voice data received through the microphone of the electronic device being voice data of the specified user, compare a voice intensity of the voice data of the specified user with a second threshold value. According to an embodiment, the instructions may, when executed by the at least one processor individually or collectively, cause the electronic device to, based on the voice intensity of the voice data of the specified user being equal to or greater than the second threshold value, transmit the microphone switching information, which instructs to stop the transmission of the first voice data, to the selected external electronic device.

According to an embodiment, the instructions may, when executed by the at least one processor individually or collectively, cause the electronic device to, based on the distance between the electronic device and the selected external electronic device being less than the first threshold value, identify whether image data of the specified user is included in second mage data received through the camera of the electronic device According to an embodiment, the instructions may, when executed by the at least one processor individually or collectively, cause the electronic device to, when based on identifying that the image data of the specified user is included in the second image data, transmit the microphone switching information, including instructions to stop the transmission of the first voice data, to the selected external electronic device.

According to an embodiment, the instructions may, when executed by the at least one processor individually or collectively, cause the electronic device to, based on identifying that the image data of the specified user is included in the second image data, identify voice data received through the microphone of the electronic device According to an embodiment, the instructions may, when executed by the at least one processor individually or collectively, cause the electronic device to, based on the voice data received through the microphone of the electronic device being voice data of the specified user, compare a voice intensity of voice data of the specified user with a second threshold value According to an embodiment, the instructions may, when executed by the at least one processor individually or collectively, cause the electronic device to, and based on the voice intensity of the voice data of the specified user being equal to or greater than the second threshold value, transmit the microphone switching information, which instructs to stop the transmission of the first voice data, to the selected external electronic device.

According to an embodiment, the first voice data received from the selected external electronic device may include voice data obtained by filtering audio data output through a speaker of the electronic device, and the audio data may include audio data input to the first microphone of the selected external electronic device.

According to an embodiment, the instructions may, when executed by the at least one processor individually or collectively, cause the electronic device to, based on identifying an execution of the first application for sharing image data and voice data, receive, through the communication circuitry, device information from one or more external electronic devices located around the electronic device. According to an embodiment, the instructions may, when executed by the at least one processor individually or collectively, cause the electronic device to display, through the display, a list of at least one external electronic device, which transmits information regarding a sharing function for image data and voice data among the device information.

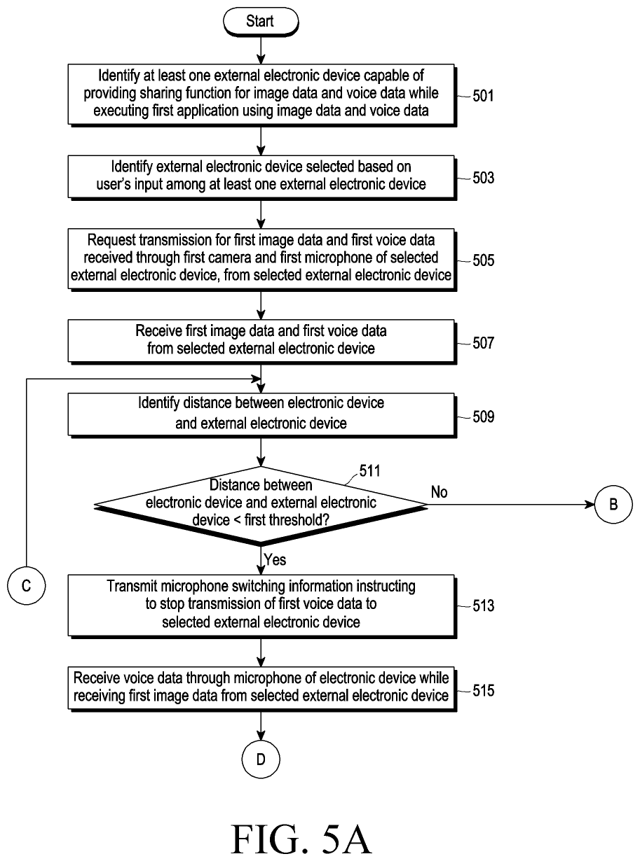

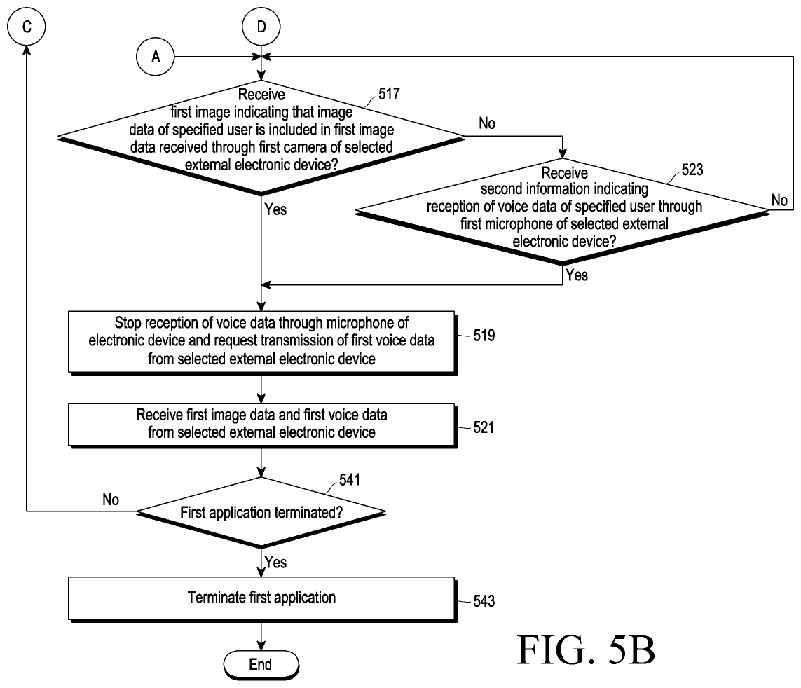

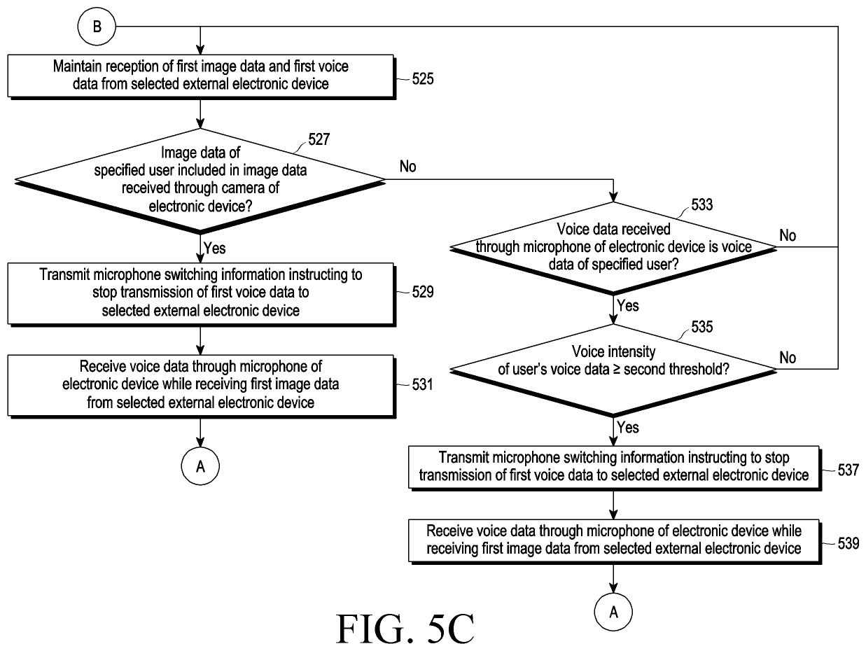

FIGS. 5A, 5B, and 5C are flowcharts illustrating an example operation for receiving voice data in an electronic device according to various embodiments. The operations of receiving voice data may include operations 501 to 543. In the following example, the operations may be sequentially performed, but may be performed non-sequentially. For example, the order of the operations may be changed, and at least two operations may be performed in parallel or other operations may be added.

In operation 501, the electronic device (e.g., the electronic device 101 of FIG. 1, the electronic device 301 of FIG. 2 and/or the electronic device 301 of FIG. 3A) may identify at least one external electronic device capable of providing a sharing function for image data and voice data while executing a first application using image data and voice data.

According to an embodiment, the electronic device may provide the image data and voice data received through the camera (e.g., the camera 380 of FIG. 3A) and the microphone (e.g., the microphone 350 of FIG. 3A) of the electronic device to the first application while executing the first application using image data and voice data.

According to an embodiment, when identifying a selection of the sharing function of the image data and voice data based on the user's input while providing the image data and voice data received through the camera and the microphone of the electronic device to the first application, the electronic device may identify at least one external electronic device that has transmitted information related to the sharing function of the image data and voice data among device information received from one or more external electronic devices located around the electronic device through the communication circuitry (e.g., the communication circuitry 390 of FIG. 3A).

In operation 503, the electronic device (e.g., the electronic device 101 of FIG. 1, the electronic device 301 of FIG. 2 and/or the electronic device 301 of FIG. 3A) may identify the external electronic device selected based on an input (e.g., the user's input) among the at least one external electronic device.

According to an embodiment, the electronic device may display a list of at least one external electronic device having transmitted information related to the sharing function of the image data and voice data through the display (e.g., the display 360 of FIG. 3A).

According to an embodiment, the electronic device may identify the external electronic device (e.g., the external electronic device 201 of FIG. 2) selected based on the user's input from a list of the at least one external electronic device.

In operation 505, the electronic device (e.g., the electronic device 101 of FIG. 1, the electronic device 301 of FIG. 2 and/or the electronic device 301 of FIG. 3A) may request transmission of first image data and first voice data received through the first camera and first microphone of the selected external electronic device from the selected external electronic device.

In operation 507, the electronic device (e.g., the electronic device 101 of FIG. 1, the electronic device 301 of FIG. 2 and/or the electronic device 301 of FIG. 3A) may receive the first image data and first voice data from the selected external electronic device.

According to an embodiment, to prevent and/or reduce echo, he first voice data received from the selected external electronic device may include voice data obtained by filtering audio data output through a speaker 355 of the electronic device 301, and the audio data may include audio data input to the first microphone of the selected external electronic device.

According to an embodiment, when receiving the first image data and first voice data from the selected external electronic device (e.g., the external electronic device 201 of FIG. 2), the electronic device may provide the first image data and the first voice data to the first application.

In operation 509, the electronic device (e.g., the electronic device 101 of FIG. 1, the electronic device 301 of FIG. 2 and/or the electronic device 301 of FIG. 3A) may identify the distance between the electronic device and the external electronic device.

According to an embodiment, when identifying a movement of the electronic device using an acceleration sensor among the sensors (e.g., the sensor 376 of FIG. 3A), the processor 320 may identify (measure) the distance between the electronic device and the selected external electronic device using distance measurement technology based on a network (e.g., Bluetooth low energy (BLE)), Wi-Fi, and/or UWB).

In operation 511, the electronic device (e.g., the electronic device 101 of FIG. 1, the electronic device 301 of FIG. 2 and/or the electronic device 301 of FIG. 3A) may compare the distance between the electronic device and the external electronic device with a first threshold.

In operation 511, when identifying that the distance between the electronic device and the external electronic device is less than the first threshold, the electronic device (e.g., the electronic device 101 of FIG. 1, the electronic device 301 of FIG. 2 and/or the electronic device 301 of FIG. 3A) may transmit microphone switching information instructing to stop the transmission of the first voice data to the selected external electronic device in operation 513.

In operation 515, the electronic device (e.g., the electronic device 101 of FIG. 1, the electronic device 301 of FIG. 2 and/or the electronic device 301 of FIG. 3A) may receive voice data through the microphone of the electronic device while receiving the first image data from the selected external electronic device.

According to an embodiment, the electronic device may provide the first application with the first image data received from the selected external electronic device and the voice data (e.g., the second voice data) received through the microphone of the electronic device.

In operation 517, the electronic device (e.g., the electronic device 101 of FIG. 1, the electronic device 301 of FIG. 2 and/or the electronic device 301 of FIG. 3A) may identify whether first image is received which indicating that image data of the specified user is included in the first image data received through the first camera of the selected external electronic device.

According to an embodiment, the electronic device may analyze the first image data received through the first camera of the selected external electronic device and identify whether the first image is received which indicates that the image data corresponding to the face of the specified user is included in the first image data based on the result of analysis.

In operation 517, when receiving the reception of the first image indicating that the image data of the specified user is included in the first image data received through the first camera of the selected external electronic device, the electronic device (e.g., the electronic device 101 of FIG. 1, the electronic device 301 of FIG. 2 and/or the electronic device 301 of FIG. 3A) may stop the reception of voice data through the microphone of the electronic device and request transmission of the first voice data from the selected external electronic device in operation 519.

In operation 521, the electronic device (e.g., the electronic device 101 of FIG. 1, the electronic device 301 of FIG. 2 and/or the electronic device 301 of FIG. 3A) may receive the first image data and first voice data from the selected external electronic device.

According to an embodiment, when receiving the first image data and first voice data from the selected external electronic device (e.g., the external electronic device 201 of FIG. 2), the electronic device may provide the first image data and the first voice data to the first application.

In operation 523, the electronic device (e.g., the electronic device 101 of FIG. 1, the electronic device 301 of FIG. 2 and/or the electronic device 301 of FIG. 3A) may identify whether second information indicating reception of the voice data of the specified user through the first microphone of the selected external electronic device is received.

In operation 523, when identifying the reception of the second information indicating the reception of the voice data of the specified user through the first microphone of the selected external electronic device, the electronic device (e.g., the electronic device 101 of FIG. 1, the electronic device 301 of FIG. 2 and/or the electronic device 301 of FIG. 3A) may stop the reception of the voice data through the microphone of the electronic device and request transmission of the first voice data from the selected external electronic device in operation 519, and receive the first image data and the first voice data from the selected external electronic device in operation 521.

In operation 511, when identifying that the distance between the electronic device and the external electronic device is equal to or greater than the first threshold, the electronic device (e.g., the electronic device 101 of FIG. 1, the electronic device 301 of FIG. 2 and/or the electronic device 301 of FIG. 3A) may maintain the reception of the first image data and first voice data from the selected external electronic device in operation 525.

In operation 527, the electronic device (e.g., the electronic device 101 of FIG. 1, the electronic device 301 of FIG. 2 and/or the electronic device 301 of FIG. 3A) may identify that the image data of the specified user is included in the image data received through the camera of the electronic device.

According to an embodiment, the electronic device may identify whether the image data of the specified user is included in the image data (e.g., the second image data) received through the camera (e.g., the camera 380 of FIG. 3A) of the electronic device while receiving the first image data and first voice data from the selected external electronic device (e.g., the external electronic device 201 of FIG. 2).

According to an embodiment, the image data of the specified user may represent the image data corresponding to the face of the specified user.

In operation 527, when identifying that the image data of the specified user is included in the image data received through the camera of the electronic device, the electronic device (e.g., the electronic device 101 of FIG. 1, the electronic device 301 of FIG. 2 and/or the electronic device 301 of FIG. 3A) may transmit microphone switching information instructing to stop the transmission of the first voice data to the selected external electronic device in operation 529.

In operation 531, the electronic device (e.g., the electronic device 101 of FIG. 1, the electronic device 301 of FIG. 2 and/or the electronic device 301 of FIG. 3A) may receive voice data through the microphone of the electronic device while receiving the first image data from the selected external electronic device.

In operation 527, when failing to identify that the image data of the specified user is included in the image data received through the camera of the electronic device, the electronic device (e.g., the electronic device 101 of FIG. 1, the electronic device 301 of FIG. 2 and/or the electronic device 301 of FIG. 3A) may identify whether the voice data received through the microphone of the electronic device is voice data of the specified user in operation 533.

In operation 533, when identifying that the voice data received through the microphone of the electronic device is voice data of the specified user, the electronic device (e.g., the electronic device 101 of FIG. 1, the electronic device 301 of FIG. 2 and/or the electronic device 301 of FIG. 3A) may compare the voice intensity of the voice data of the user with the second threshold in operation 535.

In operation 535, when identifying that the voice intensity of the voice data of the user is equal to or greater than the second threshold, the electronic device (e.g., the electronic device 101 of FIG. 1, the electronic device 301 of FIG. 2 and/or the electronic device 301 of FIG. 3A) may transmit the microphone switching information instructing to stop the transmission of the first voice data to the selected external electronic device in operation 537.

In operation 539, the electronic device (e.g., the electronic device 101 of FIG. 1, the first electronic device 301 of FIG. 2 and/or the electronic device 301 of FIG. 3A) may receive voice data through the microphone of the electronic device while receiving the first image data from the selected external electronic device.

In operation 533, when failing to identify that the voice data received through the microphone of the electronic device is voice data of the specified user, the electronic device (e.g., the electronic device 101 of FIG. 1, the electronic device 301 of FIG. 2 and/or the electronic device 301 of FIG. 3A) may maintain the reception of the first image data and first voice data from the selected external electronic device in operation 525.

In operation 535, when identifying that the voice intensity of the voice data of the user is less than the second threshold, the electronic device (e.g., the electronic device 101 of FIG. 1, the electronic device 301 of FIG. 2 and/or the electronic device 301 of FIG. 3A) may maintain the reception of the first image data and first voice data from the selected external electronic device in operation 525.

In operation 541, when identifying termination of the first application using image data and voice data has not occurred, the electronic device (e.g., the electronic device 101 of FIG. 1, the electronic device 301 of FIG. 2 and/or the electronic device 301 of FIG. 3A) may identify the distance between the electronic device and the selected external electronic device in operation 509.

In operation 541, when identifying the termination of the first application using image data and voice data, the electronic device (e.g., the electronic device 101 of FIG. 1, the electronic device 301 of FIG. 2 and/or the electronic device 301 of FIG. 3A) may terminate the first application using image data and voice data in operation 543.

According to an embodiment, when the first application using image data and voice data is terminated, the electronic device (e.g., the electronic device 101 of FIG. 1, the electronic device 301 of FIG. 2 and/or the electronic device 301 of FIG. 3A) may instruct to stop the transmission of the first image data and first voice data to the selected external electronic device.

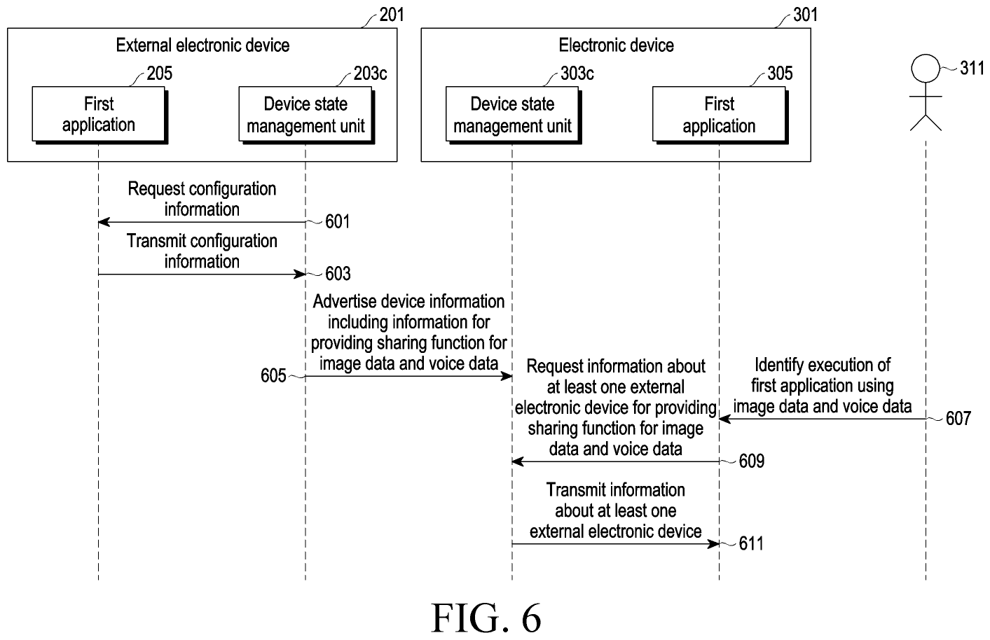

FIG. 6 is a signal flow diagram illustrating an example operation of identifying at least one first external electronic device capable of providing a sharing function for image data and voice data in an electronic device according to various embodiments. The operations of identifying at least one first external electronic device may include operations 601 to 611. In the following example, the operations may be sequentially performed, but may be performed non-sequentially. For example, the order of the operations may be changed, and at least two operations may be performed in parallel or other operations may be added.

According to an embodiment, the external electronic device 201 may include a first application 205 and a device state management unit 203c.

According to an embodiment, the first application 205 may transmit configuration information indicating that image data and voice data may be shared to the device state management unit.

According to an embodiment, the device state management unit 203c may request configuration information capable of identifying whether first image data and first voice data received through the first camera and first microphone of the external electronic device 201 may be shared from the first application 205 and advertise device information that includes information capable of providing the sharing function for image data and voice data in the external electronic device 201.

According to an embodiment, the electronic device 301 may include a first application 305 and a device state management unit 303c.

According to an embodiment, the first application 305 may request information about at least one external electronic device capable of providing the sharing function for image data and voice data from the device state management unit 303c.

According to an embodiment, the device state management unit 303c may transmit information about the at least one external electronic device capable of providing the sharing function for image data and voice data to the first application 305.

In operation 601, the device state management unit 203c of the external electronic device 201 (e.g., the external electronic device 201 of FIG. 2) may request configuration information for identifying whether the image data and voice data may be shared from the first application using image data and voice data.

According to an embodiment, the device state management unit 203c may request configuration information for identifying whether the first image data and first voice data received through the first camera and first microphone of the external electronic device 201 may be shared from the first application.

In operation 603, the external electronic device 201 (e.g., the external electronic device 201 of FIG. 2) may transmit the configuration information indicating that the image data and voice data may be shared to the device state management unit 203c.

In operation 605, the device state management unit 203c of the external electronic device 201 (e.g., the external electronic device 201 of FIG. 2) may advertise, every predetermined period, device information including the information for providing the sharing function for image data and voice data in the external electronic device 201 through the BLE communication circuitry of the communication circuitry of the external electronic device.

In operation 607, the electronic device 301 (e.g., the electronic device 301 of FIG. 2 and/or the electronic device 301 of FIG. 3A) may identify the execution of the first application using the image data and voice data based on an input of the user 311.

In operation 609, the first application 305 of the electronic device 301 (e.g., the electronic device 301 of FIG. 2 and/or the electronic device 301 of FIG. 3A) may request information about at least one external electronic device capable of providing the sharing function for image data and voice data from the device state management unit 303c.

In operation 611, the device state management unit 303c of the electronic device 301 (e.g., the electronic device 301 of FIG. 2 and/or the electronic device 301 of FIG. 3A) may transmit, to the first application 305, information about at least one external electronic device capable of providing the sharing function for image data and voice data.

According to an embodiment, the device state management unit 303c may identify at least one external electronic device capable of providing a sharing function for image data and voice data among the device information received from one or more external electronic devices located around the electronic device 301 through the BLE communication circuitry of the communication circuitry of the electronic device 301 and provide a list of the at least one external electronic device.

According to an embodiment, when identifying that a new piece of device information is added which includes information capable of providing the sharing function for image data and voice data while providing the list of the at least one external electronic device, the device state management unit 303c may update the list of the at least one external electronic device based on the new device information.

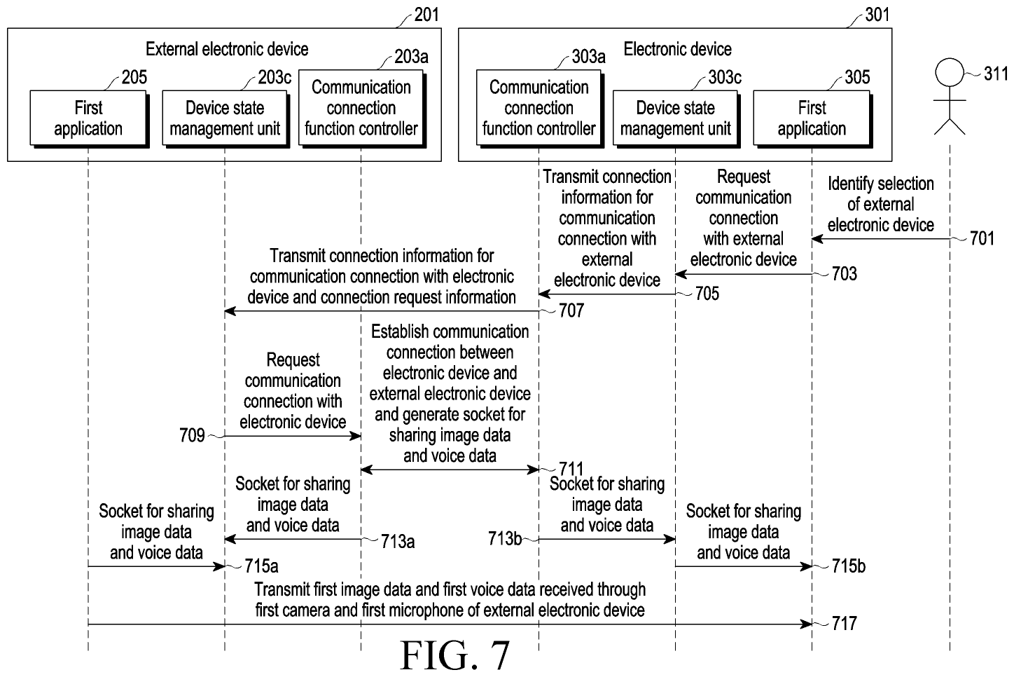

FIG. 7 is a signal flow diagram illustrating an example operation of receiving image data and voice data from an external electronic device in an electronic device according to various embodiments. The operations of receiving image data and voice data from an external electronic device may include operations 701 to 717. In the following example, the operations may be sequentially performed, but may be performed non-sequentially. For example, the order of the operations may be changed, and at least two operations may be performed in parallel or other operations may be added.

In operation 701, the first application 305 of the electronic device 301 (e.g., the electronic device 301 of FIG. 2 and/or the electronic device 301 of FIG. 3A) may identify a selection of an external electronic device 201.

According to an embodiment, the first application 305 may identify the selection of the external electronic device 201 based on the user's input from among at least one external electronic device capable of providing the sharing function for image data and voice data.

In operation 703, the first application 305 of the electronic device 301 (e.g., the electronic device 301 of FIG. 2 and/or the electronic device 301 of FIG. 3A) may request communication connection with the external electronic device from the device state management unit 303c.

In operation 705, the device state management unit 303c of the electronic device 301 (e.g., the electronic device 301 of FIG. 2 and/or the electronic device 301 of FIG. 3A) may transmit connection information for communication connection with the external electronic device to the communication connection function controller 303a for communication connection of the external electronic device.

In operation 707, the communication connection function controller 303a of the electronic device 301 (e.g., the electronic device 301 of FIG. 2 and/or the electronic device 301 of FIG. 3A) may transmit connection request information together with the connection information for communication connection with the electronic device to the external electronic device 201 through the communication circuitry (e.g., BLE communication circuitry) of the electronic device based on the connection information for communication connection with the external electronic device.

According to an embodiment, the communication connection function controller 203a of the external electronic device 201 may receive the connection request information together with the connection information for communication connection with the electronic device 301 transmitted from the communication connection function controller 303a of the electronic device 301.

According to an embodiment, the communication connection function controller 203a of the external electronic device 201 may transmit, to the device state management unit 203c, the connection request information together with the connection information for communication connection with the electronic device 301.

According to an embodiment, the device state management unit 203c of the external electronic device 201 may store the connection request information together with the connection information for communication connection with the electronic device 301 received from the communication connection function controller 203a.

In operation 709, the device state management unit 203c of the external electronic device 201 (e.g., the external electronic device 201 of FIG. 2) may request communication connection with the electronic device 301 from the communication connection function controller 203a.

In operation 711, a communication connection may be established between the electronic device 301 and the external electronic device 201 through the communication connection function controller 303a of the electronic device 301 (e.g., the electronic device 301 of FIG. 2 and/or the electronic device 301 of FIG. 3A) and the external electronic device 201 (e.g., the external electronic device 201 of FIG. 2) and a socket for sharing the image data and voice data may be generated.

In operation 713a, the communication connection function controller 203a of the external electronic device 201 (e.g., the external electronic device 201 of FIG. 2) may transmit the socket for sharing the image data and voice data to the device state management unit 203c and, in operation 715a, the device state management unit 203c may transmit the socket for sharing the image data and voice data to the first application 205.

In operation 713b, the communication connection function controller 303a of the electronic device 301 (e.g., the electronic device 301 of FIG. 2 and/or the electronic device 301 of FIG. 3A) may transmit the socket for sharing the image data and voice data to the device state management unit 303c and, in operation 715b, the device state management unit 303c may transmit the socket for sharing the image data and voice data to the first application 305.

In operation 717, the first application 205 of the external electronic device 201 (e.g., the external electronic device 201 of FIG. 2) may transmit the first image data and first voice data received through the first camera and first microphone of the external electronic device 201 to the electronic device 301.

According to an embodiment, to prevent and/or reduce echo that occurs when the audio data output through the speaker of the electronic device 301 is input to the first microphone of the external electronic device 201, the first application 205 may filter (remove) the audio data output through the speaker of the electronic device 301 input through the first microphone of the external electronic device 201 from the first voice data received through the first microphone of the external electronic device 201 and then transmit the first voice data to the electronic device 301.

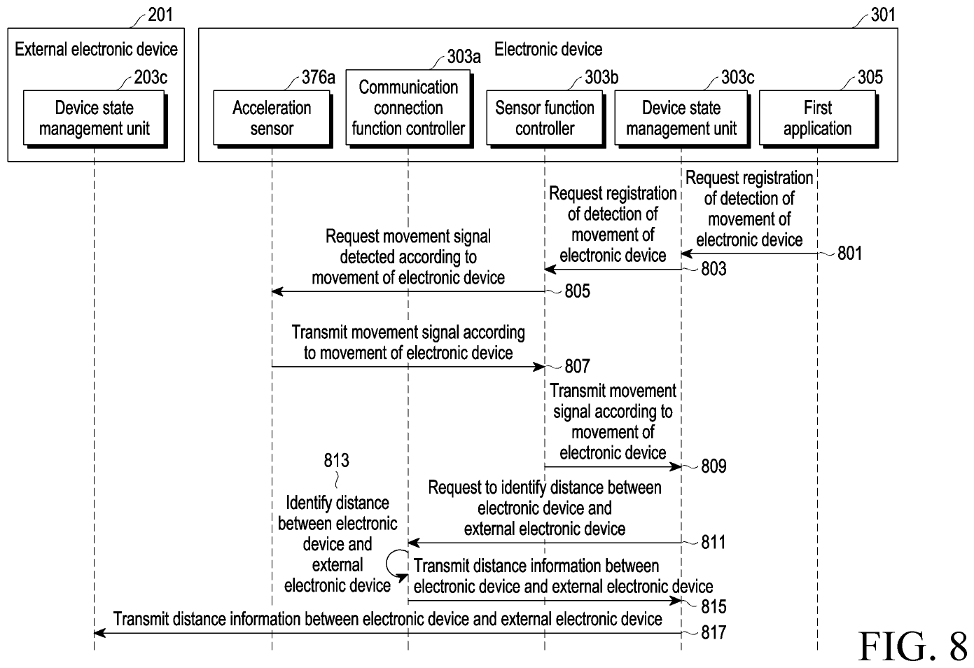

FIG. 8 is a signal flow diagram illustrating an example operation of identifying a distance between an electronic device and an external electronic device in the electronic device according to various embodiments. The operations of identifying the distance between the electronic device and the external electronic device may include operations 801 to 817. In the following example, the operations may be sequentially performed, but may be performed non-sequentially. For example, the order of the operations may be changed, and at least two operations may be performed in parallel or other operations may be added.

In operation 801, the first application 305 of the electronic device 301 (e.g., the electronic device 301 of FIG. 2 and/or the electronic device 301 of FIG. 3A) may request the device state management unit 303c to register detection of a movement of the electronic device and, in operation 803, the device state management unit 303c may request the sensor function controller 303b to register detection of a movement of the electronic device.

In operation 805, the sensor function controller 303b of the electronic device 301 (e.g., the electronic device 301 of FIG. 2 and/or the electronic device 301 of FIG. 3A) may request a movement signal detected according to the movement of the electronic device 301 from the acceleration sensor 376a among sensors.

In operation 807, when identifying a movement of the electronic device 301, the acceleration sensor 376a of the electronic device 301 (e.g., the electronic device 301 of FIG. 2 and/or the electronic device 301 of FIG. 3A) may transmit a movement signal according to the movement of the electronic device 301 to the sensor function controller 303b.

In operation 809, the sensor function controller 303b of the electronic device 301 (e.g., the electronic device 301 of FIG. 2 and/or the electronic device 301 of FIG. 3A) may transmit the movement signal according to the movement of the electronic device 301 received from the acceleration sensor 376a to the device state management unit 303c.

In operation 811, the device state management unit 303c of the electronic device 301 (e.g., the electronic device 301 of FIG. 2 and/or the electronic device 301 of FIG. 3A) may request the communication connection function controller 303a to identify (measure) the distance between the electronic device 301 and the external electronic device 201.

In operation 813, the communication connection function controller 303a of the electronic device 301 (e.g., the electronic device 301 of FIG. 2 and/or the electronic device 301 of FIG. 3A) may identify (measure) the distance between the electronic device 301 and the external electronic device 201, and in operation 815, transmit the distance information between the electronic device 301 and the external electronic device 201 to the device state management unit 303c.

According to an embodiment, the communication connection function controller 303a may measure (identify) the distance through the distance measurement technology based on network (Bluetooth low energy (BLE) communication circuitry, Wi-Fi communication circuitry, and/or UWB communication circuitry).

In operation 817, the device state management unit 303c of the electronic device 301 (e.g., the electronic device 301 of FIG. 2 and/or the electronic device 301 of FIG. 3A) may transmit distance information between the electronic device 301 and the external electronic device 201 to the device state management unit 203c of the external electronic device 201.

According to an embodiment, the device state management unit 303c may compare the distance between the electronic device 301 and the external electronic device 201 with a first threshold to determine whether the distance between the electronic device 301 and the external electronic device 201 is less than the first threshold, or equal to or greater than the first threshold.

According to an embodiment, to inform the external electronic device 201 in advance whether to transmit the microphone switching information instructing to stop the transmission of the first voice data to the external electronic device 201, whenever identifying the movement of the electronic device 301, the electronic device 301 may transmit the distance information between the electronic device 301 and the external electronic device 201, updated through operations 807 to 817, to the external electronic device 201.

The external electronic device 201 according to an embodiment may transmit, to the electronic device 201, distance information between the external electronic device 201 and the electronic device 301 updated through the same operations as operations 807 to 817 whenever identifying the movement of the external electronic device 201 in the same manner as the electronic device 301.

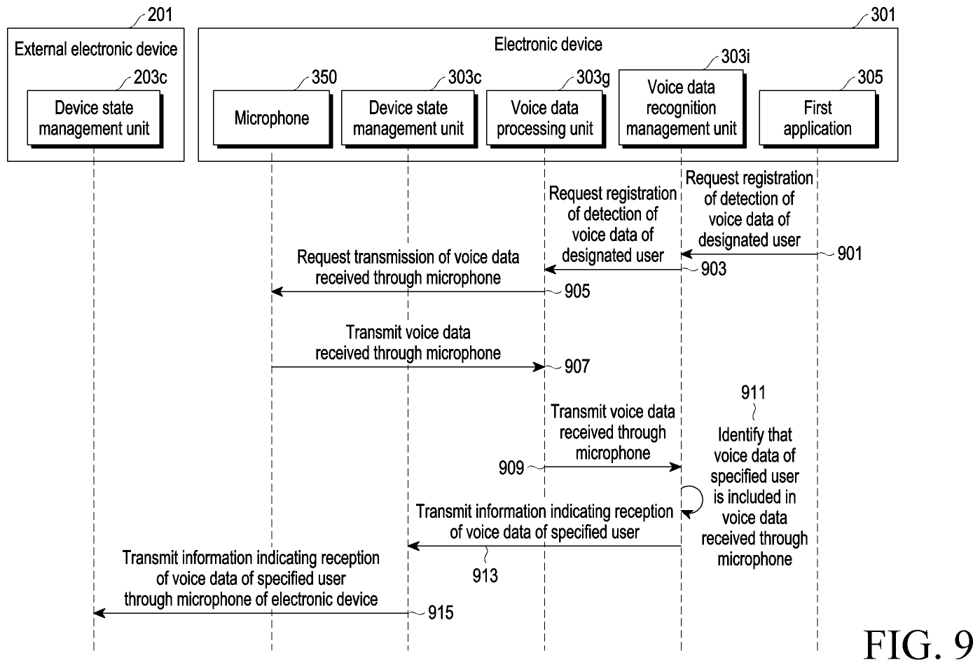

FIG. 9 is a signal flow diagram illustrating an example operation of identifying voice data of a specified user in an electronic device according to various embodiments. The operations of identifying the voice data of the specified user may include operations 901 to 915. In the following example, the operations may be sequentially performed, but may be performed non-sequentially. For example, the order of the operations may be changed, and at least two operations may be performed in parallel or other operations may be added.

In operation 901, the first application 305 of the electronic device 301 (e.g., the electronic device 301 of FIG. 2 and/or the electronic device 301 of FIG. 3A) may request the voice data recognition management unit 303i to register detection of the voice data of the specified user and, in operation 903, the voice data recognition management unit 303i may request the voice data processing unit 303g to register detection of the voice data of the specified user.

In operation 905, the voice data processing unit 303g of the electronic device 301 (e.g., the electronic device 301 of FIG. 2 and/or the electronic device 301 of FIG. 3A) may request the microphone 350 to transmit voice data received through the microphone 350.

In operation 907, the microphone 350 of the electronic device 301 (e.g., the electronic device 301 of FIG. 2 and/or the electronic device 301 of FIG. 3A) may transmit the voice data received through the microphone 350 to the voice data processing unit 303g and, in operation 909, the voice data processing unit 303g may transmit the voice data received through the microphone 350 to the voice data recognition management unit 303i.

In operation 911, the voice data recognition management unit 303i of the electronic device 301 (e.g., the electronic device 301 of FIG. 2 and/or the electronic device 301 of FIG. 3A) may identify that the voice data of the specified user is included in the voice data received through the microphone 350.

According to an embodiment, the voice data recognition management unit 303i may identify the voice data of the specified user among the received voice data using a voice detection algorithm.

According to an embodiment, the voice data recognition management unit 303i may compare the voice intensity of the voice data of the specified user with the second threshold to identify whether the voice intensity of the voice data of the specified user is equal to or greater than the second threshold.

In operation 913, the voice data recognition management unit 303i of the electronic device 301 (e.g., the electronic device 301 of FIG. 2 and/or the electronic device 301 of FIG. 3A) may transmit information indicating the reception of the voice data of the specified user to the device state management unit 303c.

In operation 915, the device state management unit 303c of the electronic device 301 (e.g., the electronic device 301 of FIG. 2 and/or the electronic device 301 of FIG. 3A) may transmit information indicating the reception of the voice data of the specified user through the microphone of the electronic device 301 to the device state management unit 203c of the external electronic device 201.

According to an embodiment, the electronic device 301 may transmit and share, to/with the external electronic device 201, information indicating the reception of the voice data of the specified user through the microphone of the electronic device 301 updated through operations 907 to 915 whenever identifying the reception of the voice data of the specified user through the microphone of the first electronic device.

According to an embodiment, when receiving information indicating the reception of the voice data of the specified user through the microphone of the electronic device 301 from the electronic device 301, the external electronic device 201 may wait for reception of the microphone switching information instructing to stop the transmission of the first voice data to the external electronic device 201 from the electronic device 301.

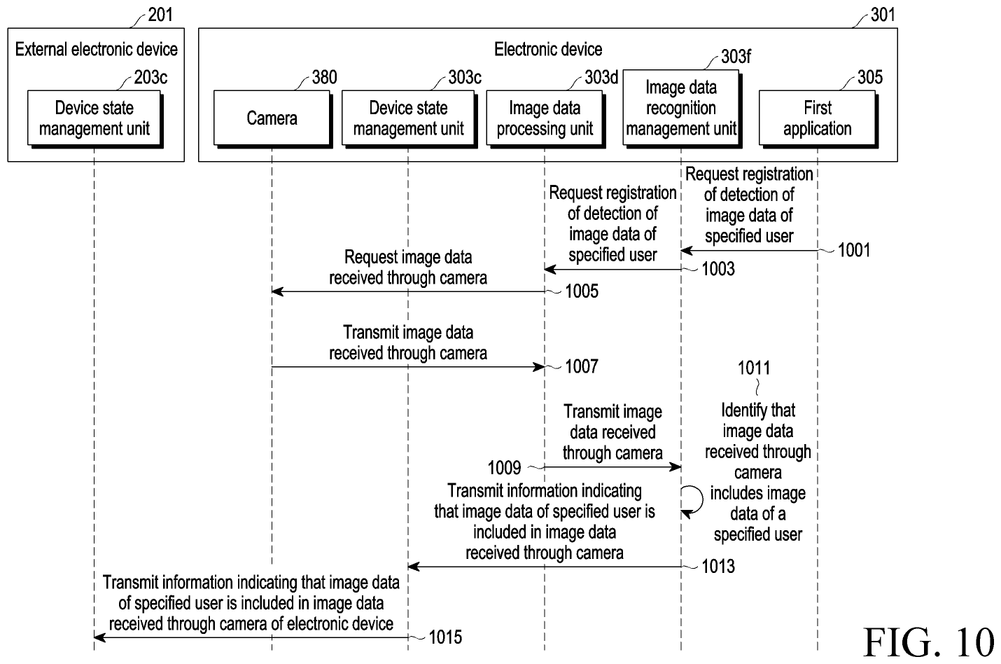

FIG. 10 is a signal flow diagram illustrating an example operation of identifying image data of a specified user in an electronic device according to an embodiment. The operations of identifying the image data of the specified user may include operations 1001 to 1015. In the following example, the operations may be sequentially performed, but may be performed non-sequentially. For example, the order of the operations may be changed, and at least two operations may be performed in parallel or other operations may be added.

In operation 1001, the first application 305 of the electronic device 301 (e.g., the electronic device 301 of FIG. 2 and/or the electronic device 301 of FIG. 3A) may request the image data recognition management unit 303f to register detection of the image data of the specified user and, in operation 1003, the image data recognition management unit 303f may request the image data processing unit 303d to register detection of the image data of the specified user.

According to an embodiment, the image data of the specified user may represent the image data corresponding to the face of the specified user.

In operation 1005, the image data processing unit 303d of the electronic device 301 (e.g., the electronic device 301 of FIG. 2 and/or the electronic device 301 of FIG. 3A) may request the image data received from the camera 380 from the camera 380.

In operation 1007, the camera 380 of the electronic device 301 (e.g., the electronic device 301 of FIG. 2 and/or the electronic device 301 of FIG. 3A) may transmit the image data received through the camera 380 to the image data processing unit 303d and, in operation 1009, the image data processing unit 303d may transmit the image data received through the camera 380 to the image data recognition management unit 303f.

In operation 1011, the image data recognition management unit 303f of the electronic device 301 (e.g., the electronic device 301 of FIG. 2 and/or the electronic device 301 of FIG. 3A) may identify whether the image data of the specified user is included in the image data received through the camera 380.

According to an embodiment, the image data recognition management unit 303f may that the image data of the specified user is included in the image data received through the camera 380.

In operation 1013, the image data management unit 303f of the electronic device 301 (e.g., the electronic device 301 of FIG. 2 and/or the electronic device 301 of FIG. 3A) may transmit information indicating that the image data of the specified user is included in the image data received through the camera 380 to the device state management unit 303c.

In operation 1015, the device state management unit 303c of the electronic device 301 (e.g., the electronic device 301 of FIG. 2 and/or the electronic device 301 of FIG. 3A) may transmit information indicating that the image data of the specified user is included in the image data received through the camera of the electronic device 301 to the device state management unit 203c of the external electronic device 201.

The electronic device 301 according to an embodiment may transmit, to the external electronic device 201, information indicating the reception of the image data of the specified user through the camera of the electronic device 301 updated through operations 1011 to 1015 whenever identifying that the image data of the specified user is included in the image data received through the camera of the electronic device.

According to an embodiment, when receiving information indicating the reception of the image data corresponding to the face of the specified user through the camera of the electronic device 301 from the electronic device 301, the external electronic device 201 may wait for reception of the microphone switching information instructing to stop the transmission of the first voice data to the external electronic device 201 from the electronic device 301.

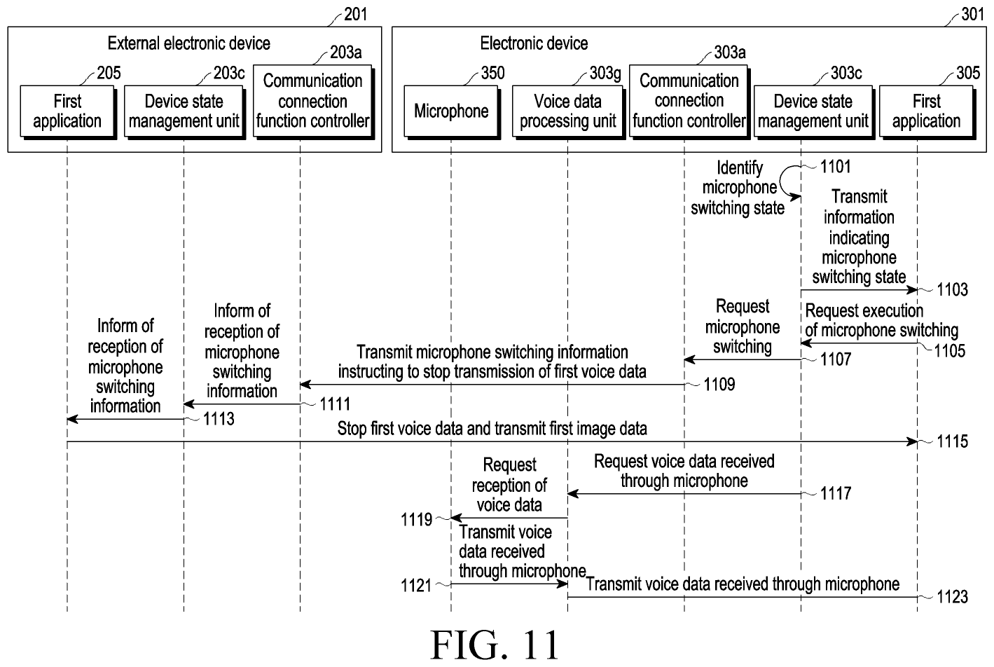

FIG. 11 is a signal flow diagram illustrating an example operation of receiving voice data in an electronic device according to an embodiment. The operations of identifying the image data of the specified user may include operations 1101 to 1123. In the following example, the operations may be sequentially performed, but may be performed non-sequentially. For example, the order of the operations may be changed, and at least two operations may be performed in parallel or other operations may be added.

In operation 1101, the device state management unit 303c of the electronic device 301 (e.g., the electronic device 301 of FIG. 2 and/or the electronic device 301 of FIG. 3A) may identify the microphone switching state.

According to an embodiment, the device state management unit 303c may identify that the state is the microphone switching state if at least one is met among identifying that the distance between the first electronic device 301 and the external electronic device 201 is less than the first threshold through the operations of FIG. 8 while receiving the first image data and first voice data from the external electronic device 201, identifying that the image of the specified user (e.g., the owner of the electronic device and the external electronic device) is included in the image obtained through the camera of the electronic device through the operations of FIG. 10, or identifying that the voice intensity of the voice data of the specified user (e.g., the owner of the electronic device and the external electronic device) obtained through the microphone of the electronic device 301 is equal to or greater than the second threshold through the operations of FIG. 9.

In operation 1103, the device state management unit 303c of the electronic device 301 (e.g., the electronic device 301 of FIG. 2 and/or the electronic device 301 of FIG. 3A) may transmit information indicating the microphone switching state to the first application 305.

In operation 1105, the first application 305 of the electronic device 301 (e.g., the electronic device 301 of FIG. 2 and/or the electronic device 301 of FIG. 3A) may request the device state management unit 303c to execute microphone switching.

In operation 1107, the device state management unit 303c of the electronic device 301 (e.g., the electronic device 301 of FIG. 2 and/or the electronic device 301 of FIG. 3A) may request the communication connection function controller 303a to perform microphone switching.

In operation 1109, the communication connection function controller 303a of the electronic device 301 (e.g., the electronic device 301 of FIG. 2 and/or the electronic device 301 of FIG. 3A) may transmit microphone switching information instructing to stop the transmission of the first voice data to the communication connection function controller 203a.

In operation 1111, the communication connection function controller 203a of the external electronic device 201 (e.g., the external electronic device 201 of FIG. 2) may inform the device state management unit 203c of the reception of microphone switching information and, in operation 1113, the device state management unit 203c may inform the first application 205 of the reception of the microphone switching information.

In operation 1115, the first application 205 of the external electronic device 201 (e.g., the external electronic device 201 of FIG. 2) according to an embodiment may stop the transmission of the first voice data to the electronic device 302 and transmit the first image data.

In operation 1117, the device state management unit 303c of the electronic device 301 (e.g., the electronic device 301 of FIG. 2 and/or the electronic device 301 of FIG. 3A) may request the voice data received through the microphone 350 from the voice data processing unit 303g.

In operation 1119, the voice data processing unit 303g of the electronic device 301 (e.g., the electronic device 301 of FIG. 2 and/or the electronic device 301 of FIG. 3A) may request the microphone 350 to receive voice data and, in operation 1121, the microphone 350 may transmit the voice data received through the microphone to the voice data processing unit 303g.

In operation 1123, the voice data processing unit 303g of the electronic device 301 (e.g., the electronic device 301 of FIG. 2 and/or the electronic device 301 of FIG. 3A) may transmit the voice data received through the microphone to the first application 305.

According to an embodiment, the first application 305 of the electronic device 301 (e.g., the electronic device 301 of FIG. 2 and/or the electronic device 301 of FIG. 3A) may receive first image data received from the external electronic device.

According to an embodiment, a method for receiving voice data in an electronic device (e.g., 101 of FIG. 1; 301 of FIG. 2; 301 of FIG. 3A) may comprise: based on identifying a selection of a sharing function for image data and voice data based on an input while executing a first application which uses the image data and the voice data, identifying at least one external electronic device capable of providing the sharing function for the image data and the voice data among one or more external electronic devices located around the electronic device. According to an embodiment, the method may comprise, based on identifying an external electronic device selected from among the at least one external electronic device, requesting, through communication circuitry of the electronic device, transmission of first image data and first voice data received through a first camera and a first microphone of the selected external electronic device from the selected external electronic device. According to an embodiment, the method may comprise identifying a distance between the electronic device and the selected external electronic device, while receiving the first image data and the first voice data from the selected external electronic device through the communication circuitry. According to an embodiment, the method may comprise, the distance between the electronic device and the selected external electronic device being less than a first threshold value, transmitting microphone switching information, which instructs to stop the transmission of the first voice data while maintaining the reception of the first image data, to the selected external electronic device. According to an embodiment, the method may comprise receiving second voice data through the microphone of the electronic device, while receiving the first image data from the selected external electronic device through communication circuitry. According to an embodiment, the method may comprise providing the first application being executed with the first image data received from the selected external electronic device and the second voice data received through the microphone of the electronic device.

According to an embodiment, the method may comprise, based on receiving, from the selected external electronic device, first information indicating that image data of a specified user is included in the first image data received through the first camera of the selected external electronic device while receiving the first image data from the selected external electronic device through the communication circuitry and the second voice data through the microphone of the electronic device, stopping the reception of the second voice data through the microphone of the electronic device, request transmission of the first voice data from the selected external electronic device, and receiving the first image data and the first voice data from the selected external electronic device.

According to an embodiment, the method may comprise: based on receiving, from the selected external electronic device, second information indicating reception of voice data of the specified user through the first microphone of the selected external electronic device while receiving the first image data from the selected external electronic device through the communication circuitry and the second voice data received through the microphone of the electronic device, stopping the reception of the second voice data through the microphone of the electronic device, requesting transmission of the first voice data from the selected external electronic device, and receiving the first image data and the first voice data from the selected external electronic device.

According to an embodiment, the method may comprise: while receiving the first image data and the first voice data from the selected external electronic device through the communication circuitry, identifying whether image data of the specified user is included in second image data received through the camera of the electronic device. According to an embodiment, the method may comprise, based on identifying that the image data of the specified user is included in the second image data, transmitting the microphone switching information, including instructions to stop the transmission of the first voice data, to the selected external electronic device.

According to an embodiment, the method may comprise, while receiving the first image data and the first voice data from the selected external electronic device, identifying voice data received through the microphone of the electronic device. According to an embodiment, the method may comprise, based on the voice data received through the microphone of the electronic device is voice data of the specified user, comparing a voice intensity of the voice data of the specified user with a second threshold value. According to an embodiment, the method may comprise, the voice intensity of the voice data of the specified user is equal to or greater than the second threshold value, transmitting the microphone switching information, including instructions to stop the transmission of the first voice data, to the selected external electronic device.

According to an embodiment, the method may comprise, based on the distance between the electronic device and the selected external electronic device being less than the first threshold value, identifying whether image data of the specified user is included in second mage data received through the camera of the electronic device. According to an embodiment, the method may comprise, based on identifying that the image data of the specified user is included in the second image data received through the camera, transmitting the microphone switching information, which instructs to stop the transmission of the first voice data, to the selected external electronic device.

According to an embodiment, the method may comprise: based on identifying that the image data of the specified user is included in the second image data received through the camera, identifying voice data received through the microphone of the electronic device. According to an embodiment, the method may comprise, based on the voice data received through the microphone of the electronic device is voice data of the specified user, comparing a voice intensity of voice data of the specified user with a second threshold value. According to an embodiment, the method may comprise, based on the voice intensity of the voice data of the specified user being equal to or greater than the second threshold value, transmitting the microphone switching information, including instructions to stop the transmission of the first voice data, to the selected external electronic device.

According to an embodiment, in the method, the first voice data received from the selected external electronic device may include voice data obtained by filtering audio data output through a speaker of the electronic device, and the audio data may include audio data input to the first microphone of the selected external electronic device.

According to an embodiment, the method may comprise, based on identifying an execution of the first application for sharing image data and voice data, receiving, through the communication circuitry, device information from one or more external electronic devices located around the electronic device. According to an embodiment, the method may comprise displaying, through the display, a list of at least one external electronic device, which transmits information regarding a sharing function for image data and voice data among the device information.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in an embodiment of the disclosure, the term “module” may include a unit implemented in hardware, software, r firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101 or the electronic device 301). For example, a processor (e.g., the processor 520) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
communication circuitry;
a display;
a microphone;
a camera;
at least one processor, comprising processing circuitry, and
memory storing instructions that, when executed by the at least one processor individually or collectively, cause the electronic device to:
based on identifying a selection of a sharing function for image data and voice data based on an input while executing a first application which uses the image data and the voice data, identify at least one external electronic device capable of providing the sharing function for the image data and the voice data among one or more external electronic devices located around the electronic device,
based on identifying that an external electronic device selected among the at least one external electronic device, request, through the communication circuitry, transmission of first image data and first voice data received through a first camera and a first microphone of the selected external electronic device from the selected external electronic device,
identify a distance between the electronic device and the selected external electronic device, while receiving the first image data and the first voice data from the selected external electronic device through the communication circuitry,
based on the distance between the electronic device and the selected external electronic device being less than a first threshold value, transmit microphone switching information, including instructions to stop the transmission of the first voice data while maintaining the reception of the first image data, to the selected external electronic device,
receive second voice data through the microphone of the electronic device, while receiving the first image data from the selected external electronic device through communication circuitry, and
provide the first application being executed with the first image data received from the selected external electronic device and the second voice data received through the microphone of the electronic device.

2. The electronic device of claim 1,
wherein the instructions, when executed by the at least one processor individually or collectively, cause the electronic device to:
based on receiving, from the selected external electronic device, first information indicating that image data of a specified user is included in the first image data received through the first camera of the selected external electronic device while receiving the first image data from the selected external electronic device through the communication circuitry and the second voice data through the microphone of the electronic device, stop the reception of the second voice data through the microphone of the electronic device, request transmission of the first voice data from the selected external electronic device, and receive the first image data and the first voice data from the selected external electronic device.

3. The electronic device of claim 1,
wherein the instructions, when executed by the at least one processor individually or collectively, cause the electronic device to:
analyze the first image data and identify whether first information indicating that the first image data includes image data corresponding to a face of the specified user based on a result of the analysis.

4. The electronic device of claim 1,
wherein the instructions, when executed by the at least one processor individually or collectively, cause the electronic device to:
based on receiving, from the selected external electronic device, second information indicating reception of voice data of the specified user through the first microphone of the selected external electronic device while receiving the first image data from the selected external electronic device through the communication circuitry and the second voice data received through the microphone of the electronic device, stop the reception of the second voice data through the microphone of the electronic device, request transmission of the first voice data from the selected external electronic device, and receive the first image data and the first voice data from the selected external electronic device.

5. The electronic device of claim 1,
wherein the instructions, when executed by the at least one processor individually or collectively, cause the electronic device to:
while receiving the first image data and the first voice data from the selected external electronic device through the communication circuitry, identify whether image data of the specified user is included in second image data received through the camera of the electronic device, and
based on identifying that the image data of the specified user is included in the second image data, transmit the microphone switching information, including instructions to stop the transmission of the first voice data, to the selected external electronic device.

6. The electronic device of claim 1,
wherein the instructions, when executed by the at least one processor individually or collectively, cause the electronic device to:
while receiving the first image data and the first voice data from the selected external electronic device through communication circuitry, identify voice data received through the microphone of the electronic device,
based on the voice data received through the microphone of the electronic device being voice data of the specified user, compare a voice intensity of the voice data of the specified user with a second threshold value, and
based on the voice intensity of the voice data of the specified user being equal to or greater than the second threshold value, transmit the microphone switching information, which instructs to stop the transmission of the first voice data, to the selected external electronic device.

7. The electronic device of claim 6,
wherein the instructions, when executed by the at least one processor individually or collectively, cause the electronic device to:
based on the distance between the electronic device and the selected external electronic device being less than the first threshold value, identify whether image data of the specified user is included in second mage data received through the camera of the electronic device, and
based on identifying that the image data of the specified user being included in the second image data, transmit the microphone switching information, including instructions to stop the transmission of the first voice data, to the selected external electronic device.

8. The electronic device of claim 7,
wherein the instructions, when executed by the at least one processor individually or collectively, cause the electronic device to:
based on identifying that the image data of the specified user is included in the second image data, identify voice data received through the microphone of the electronic device,
based on the voice data received through the microphone of the electronic device being voice data of the specified user, compare a voice intensity of voice data of the specified user with a second threshold value, and
based on the voice intensity of the voice data of the specified user being equal to or greater than the second threshold value, transmit the microphone switching information, which instructs to stop the transmission of the first voice data, to the selected external electronic device.

9. The electronic device of claim 1,
wherein the first voice data received from the selected external electronic device includes voice data obtained by filtering audio data output through a speaker of the electronic device, and
wherein the audio data includes audio data input to the first microphone of the selected external electronic device.

10. The electronic device of claim 1,
wherein the instructions, when executed by the at least one processor individually or collectively, cause the electronic device to:
based on identifying an execution of the first application for sharing image data and voice data, receive, through the communication circuitry, device information from one or more external electronic devices located around the electronic device, and
display, through the display, a list of at least one external electronic device, which transmits information regarding a sharing function for image data and voice data among the device information.

11. A method for receiving voice data in an electronic device, the method comprising:
based on identifying a selection of a sharing function for image data and voice data based on an input while executing a first application which uses the image data and the voice data, identifying at least one external electronic device capable of providing the sharing function for the image data and the voice data among one or more external electronic devices located around the electronic device;
based on identifying a first external electronic device selected from among the at least one external electronic device, requesting, through communication circuitry of the electronic device, transmission of first image data and first voice data received through a first camera and a first microphone of the selected first external electronic device from the selected first external electronic device;
identifying a distance between an electronic device and the selected external electronic device, while receiving the first image data and the first voice data from the selected first external electronic device through the communication circuitry;
based on the distance between the electronic device and the selected external electronic device being less than a first threshold value, transmitting microphone switching information, which instructs to stop the transmission of the first voice data while maintaining the reception of the first image data, to the selected external electronic device;
receiving second voice data through the microphone of the electronic device, while receiving the first image data from the selected external electronic device through communication circuitry; and
providing the first application being executed with the first image data received from the selected external electronic device and the second voice data received through the microphone of the electronic device.

12. The method of claim 11, further comprising
based on receiving, from the selected external electronic device, first information indicating that image data of a specified user is included in the first image data received through the first camera of the selected external electronic device while receiving the first image data from the selected external electronic device through the communication circuitry and the second voice data through the microphone of the electronic device, stopping the reception of the second voice data through the microphone of the electronic device, request transmission of the first voice data from the selected external electronic device, and receiving the first image data and the first voice data from the selected external electronic device.

13. The method of claim 11, further comprising
based on receiving, from the selected external electronic device, second information indicating reception of voice data of the specified user through the first microphone of the selected external electronic device while receiving the first image data from the selected external electronic device through the communication circuitry and the second voice data received through the microphone of the electronic device, stopping the reception of the second voice data through the microphone of the electronic device, requesting transmission of the first voice data from the selected external electronic device, and receiving the first image data and the first voice data from the selected external electronic device.

14. The method of claim 11, further comprising:
while receiving the first image data and the first voice data from the selected external electronic device through the communication circuitry, identifying whether image data of the specified user is included in second image data received through the camera of the electronic device; and
based on identifying that the image data of the specified user is included in the second image data, transmitting the microphone switching information, including instructions to stop the transmission of the first voice data, to the selected external electronic device.

15. The method of claim 11, further comprising:
while receiving the first image data and the first voice data from the selected external electronic device, identifying voice data received through the microphone of the electronic device;
based on the voice data received through the microphone of the electronic device being voice data of the specified user, comparing a voice intensity of the voice data of the specified user with a second threshold value; and
based on the voice intensity of the voice data of the specified user being equal to or greater than the second threshold value, transmitting the microphone switching information, including instructions to stop the transmission of the first voice data, to the selected external electronic device.

16. The method of claim 11, further comprising:
based on the distance between the electronic device and the selected external electronic device being less than the first threshold value, identifying whether image data of the specified user is included in second mage data received through the camera of the electronic device; and
based on identifying that the image data of the specified user is included in the second image data received through the camera, transmitting the microphone switching information, including instructions to stop the transmission of the first voice data, to the selected external electronic device.

17. The method of claim 16, further comprising:
based on identifying that the image data of the specified user is included in the second image data received through the camera, identifying voice data received through the microphone of the electronic device;
based on the voice data received through the microphone of the electronic device being voice data of the specified user, comparing a voice intensity of voice data of the specified user with a second threshold value; and
based on the voice intensity of the voice data of the specified user being equal to or greater than the second threshold value, transmitting the microphone switching information, including instructions to stop the transmission of the first voice data, to the selected external electronic device.

18. The method of claim 11,
wherein the first voice data received from the selected external electronic device includes voice data obtained by filtering audio data output through a speaker of the electronic device, and
wherein the audio data includes audio data input to the first microphone of the selected external electronic device.

19. The method of claim 11, further comprising:
based on identifying an execution of the first application for sharing image data and voice data, receiving, through the communication circuitry, device information from one or more external electronic devices located around the electronic device; and
displaying, through the display, a list of at least one external electronic device, which transmits information regarding a sharing function for image data and voice data among the device information.

20. A non-transitory computer readable storage medium storing instructions which, when executed by at least one processor, comprising processing circuitry, individually and/or collectively, of an electronic device, cause the electronic device to perform at least one operation, the at least one operation comprising:
based on identifying a selection of a sharing function for image data and voice data based on an input while executing a first application which uses the image data and the voice data, identifying at least one external electronic device capable of providing the sharing function for the image data and the voice data among one or more external electronic devices located around the electronic device;
based on identifying an external electronic device selected from among the at least one external electronic device, requesting, through communication circuitry of the electronic device, transmission of first image data and first voice data received through a first camera and a first microphone of the selected external electronic device from the selected external electronic device;
identifying a distance between the electronic device and the selected external electronic device, while receiving the first image data and the first voice data from the selected external electronic device through the communication circuitry;
based on the distance between the electronic device and the selected external electronic device being less than a first threshold value, transmitting microphone switching information, including instructions to stop the transmission of the first voice data while maintaining the reception of the first image data, to the selected external electronic device;
receiving second voice data through the microphone of the electronic device, while receiving the first image data from the selected external electronic device through communication circuitry; and
providing the first application being executed with the first image data received from the selected external electronic device and the second voice data received through the microphone of the electronic device.
